(19) United States
(12) Patent Application Publication
(10) Pub. No.: US 2010/0141823 A1
(43) Pub. Date: Jun. 10, 2010

(54) Image Processing Apparatus And Electronic Appliance

(75) Inventors: Norikazu TSUNEKAWA, Osaka (JP); Seiji OKADA, Osaka (JP); Akihiro MAENAKA, Osaka (JP)

Correspondence Address: NDQ&M WATCHSTONE LLP, 1300 EYE STREET, NW, SUITE 1000 WEST TOWER, WASHINGTON, DC, 20005, US

(73) Assignee: SANYO ELECTRIC CO., LTD., Osaka (JP)

(21) Appl. No.: 12/633,268

(22) Filed: Dec. 8, 2009

(30) Foreign Application Priority Data
Dec. 9, 2008 (JP) 2008313029
Oct. 9, 2009 (JP) 2009235606

(51) Int. Cl. H04N 5/222

(52) U.S. Cl. 348/333.12; 348/E05.024

(57) ABSTRACT

An output-image processing portion outputs an output image for display that contains a super-resolution-effect image indicating super-resolution effect—effect obtained when super-resolution processing is applied to an input image. Thus, having checked the output image for display, the user can recognize the degree of super-resolution effect. Accordingly, it is possible to easily judge whether or not the super-resolution processing is required.

This application is based on Japanese Patent Application No. 2008-313029 filed on Dec. 9, 2008 and Japanese Patent Application No. 2009-235606 filed on Oct. 9, 2009, the contents of which are hereby incorporated by reference.

### BACKGROUND OF THE INVENTION

1. Field of the Invention

The present invention relates to an image processing apparatus that applies predetermined processing to an input image and outputs an output image, and also relates to an electronic appliance provided with such an image processing apparatus.

2. Description of Related Art

In recent years, various proposals have been made on image-sensing apparatuses that can perform so-called super-resolution processing—processing whereby high resolution images are acquired by use of low resolution images acquired by shooting. As one example of such super-resolution processing, for example, there is known super-resolution processing whereby one high-resolution image (hereinafter referred to as the super-resolution image) is generated by use of a plurality of low-resolution images. There is known super-resolution processing using iterative calculation. In this super-resolution processing, calculation with respect to images is repeated to perform optimization, so that effective super-resolution processing can be performed.

However, super-resolution processing requires a large amount of calculation, and is thus time consuming, which is inconvenient. Particularly so is super-resolution processing whereby iterative calculation is used as described above. Thus, when the super-resolution image generated is unsatisfactory, time and electric power are wasted.

To solve this problem, there have been proposed image-sensing apparatuses that detect, when merging together a plurality of images, displacement amounts in the luminance value, the focal position, the color balance, etc. of the plurality of images, and that issue a warning when a displacement amount is large. Issuing a warning when a shooting condition varies greatly in this way makes it possible to reduce generation of wasted images.

Moreover, there have been proposed image processing apparatuses that apply super-resolution processing to a certain region specified by the user and then display the result. Displaying in such a way makes it possible to reduce the amount of calculation when the user checks the effect of the super-resolution processing.

However, when shooting is performed successively to acquire a plurality of images, the shooting conditions (such as the luminance value, the focal position, and the color balance) of the plurality of images acquired are less likely to vary. In particular, in super-resolution processing, satisfactory super-resolution images may not be acquired due to factors other than a variation in shooting conditions. Thus, in the conventional image-sensing apparatus described above, it is difficult to sufficiently reduce generation of unsatisfactory images. Moreover, in the conventional image processing apparatus described above, super-resolution processing is performed on a certain region specified by the user, and thus, depending on the region selected, the effect of the super-resolution processing may be hard to recognize. Moreover, the need for specifying a region makes operation complicated.

### SUMMARY OF THE INVENTION

According to the present invention, an image processing apparatus comprises: an image-for-display retouching portion adapted to generate a super-resolution-effect image, which indicates an effect obtained when super-resolution processing, which is processing for enhancing a resolution of an input image, is applied to an input image inputted to the image processing apparatus, and to generate, as an output image for display, an image containing the super-resolution-effect image.

According to the invention, an electronic appliance comprises:

the image processing apparatus described above;
a display device adapted to display the output image for display, which is outputted from the image processing apparatus; and
a super-resolution processing portion adapted to apply the super-resolution processing to the input image to generate a super-resolution image,
wherein the super-resolution image is recorded or played back.

### BRIEF DESCRIPTION OF THE DRAWINGS

FIG. 1 is a block diagram showing the configuration of an image-sensing apparatus embodying the present invention.

FIG. 2 is a block diagram showing the configuration of an output-image processing portion embodying the invention.

FIG. 3 is a flow chart showing one example of the operation of the output-image processing portion when super-resolution-effect display processing is performed at the time of image recording.

FIG. 4 is a flow chart showing one example of the operation of the output-image processing portion when the super-resolution-effect display processing is performed at the time of image playback.

FIG. 5A is a schematic view of an input image showing a concrete example of the result of calculating the AF evaluation value in Practical Example 1 of the super-resolution-effect display processing.

FIG. 5B is a schematic view of an input image showing a concrete example of the lens-characteristic evaluation value in Practical Example 1 of the super-resolution-effect display processing.

FIG. 5C is a schematic view of an input image displayed by combining together the AF evaluation value shown in FIG. 5A and the lens-characteristics evaluation value shown in FIG. 5B.

FIG. 6A is a schematic view showing one example of an output image for display in Practical Example 1 of the super-resolution-effect display processing.

FIG. 6B is a schematic view showing another example of the output image for display in Practical Example 1 of the super-resolution-effect display processing.

FIG. 7A is a schematic view of an input image in which the distance of displacement amount is by half a pixel.

FIG. 7B is a graph showing the relationship between an input image and the effect of super resolution.

FIG. 8A is a schematic view showing one example of an output image for display in Practical Example 2 of the super-resolution-effect display processing.

FIG. 8B is a diagram showing one example of a super-resolution effect image.

FIG. 9 is a schematic view showing another example of the output image for display in Practical Example 2 of the super-resolution-effect display processing.

FIG. 10 is a schematic view showing one example of an output image for display in Practical Example 3 of the super-resolution-effect display processing.

FIG. 11 is a schematic view showing another example of the output image for display in Practical Example 3 of the super-resolution-effect display processing.

FIG. 12A is a graph showing the luminance distribution of a subject to be shot.

FIG. 12B shows an input image acquired by shooting the subject shown in FIG. 12A.

FIG. 12C shows an input image acquired by shooting the subject shown in FIG. 12A.

FIG. 12D shows an image obtained by shifting the input image shown in FIG. 12C by a predetermined amount.

FIG. 13A is a diagram showing a method for estimating a high-resolution image from an actual low-resolution image.

FIG. 13B is a diagram showing a method for estimating an estimated low-resolution image from a high-resolution image.

FIG. 13C is a diagram showing a method for generating a differential image between the estimated low-resolution image and the actual low-resolution image.

FIG. 13D is a diagram showing a method for reconstructing a high-resolution image from a high-resolution image and a differential image.

FIG. 14 is a schematic view of an image showing how an image is divided into different regions in representative matching.

FIG. 15A is a schematic view of a reference image illustrating the representative matching.

FIG. 15B is a schematic view of a non-reference image illustrating the representative matching.

FIG. 16A is a schematic view of a reference image illustrating single-pixel displacement amount detection.

FIG. 16B is a schematic view of a non-reference image illustrating the single-pixel displacement amount detection.

FIG. 17A is a graph showing the relationship in the horizontal direction among pixel values of a representative point and sampling points when the single-pixel displacement amount detection is performed.

FIG. 17B is a graph showing the relationship in the vertical direction among pixel values of a representative point and sampling points when the single-pixel displacement amount detection is performed.

FIG. 18 is a flow chart showing one example of operation when the super-resolution-effect display processing is performed at the time of image recording.

FIG. 19 is a flow chart showing one example of operation when the super-resolution-effect display processing is performed at the time of image playback.

### DETAILED DESCRIPTION OF PREFERRED EMBODIMENTS

An embodiment of the invention will be described below with reference to the relevant drawings. First, a description will be given of an image-sensing apparatus as an example of an electronic appliance according to the invention. Note that the image-sensing apparatus described below is one, such as a digital camera, capable of recording sounds, moving images, and still images.

### Image-Sensing Apparatus

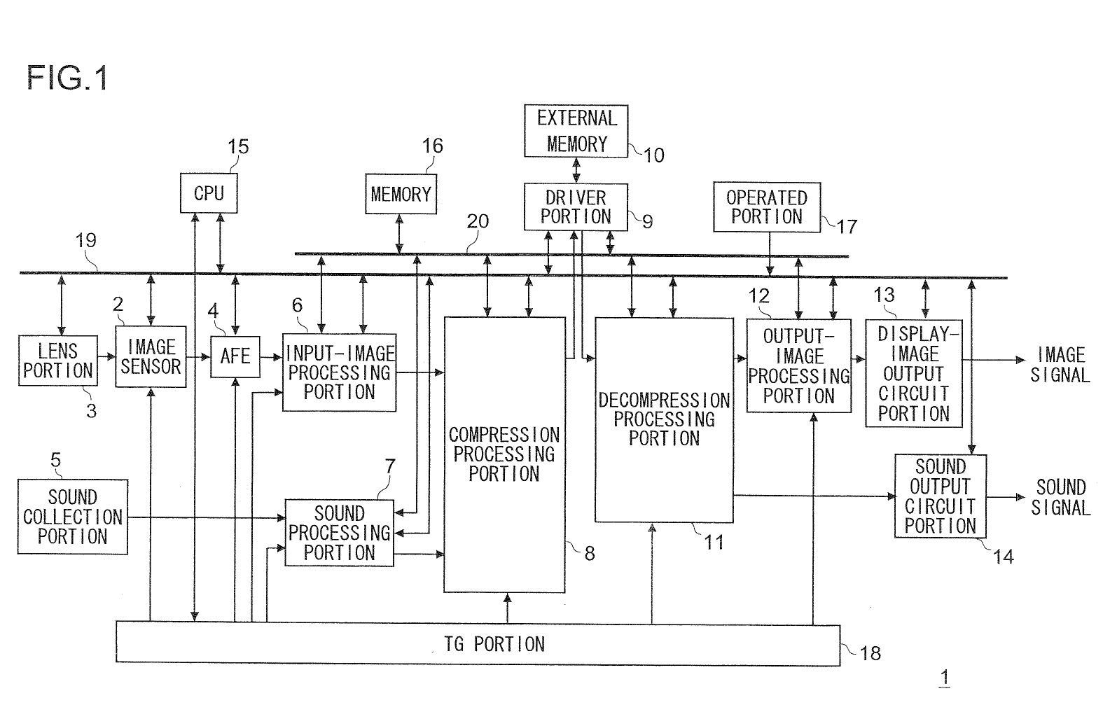

First, a description will be given of a configuration of an image-sensing apparatus with reference to FIG. 1. FIG. 1 is a block diagram showing the configuration of an image-sensing apparatus embodying the invention.

As shown in FIG. 1, the image-sensing apparatus 1 is provided with: an image sensor 2 built with a solid-state image-sensing device, such as a CCD (charge-coupled device) or CMOS (complementary metal oxide semiconductor) sensor, that converts an incident optical image into an electrical signal; and a lens portion 3 that focuses an optical image of a subject on the image sensor 2 and adjusts the amount of light etc. Together the lens portion 3 and the image sensor 2 constitute an image-sensing portion, which generates an image signal. The lens portion 3 is provided with various lenses (unillustrated), such as a zoom lens and a focus lens, and an aperture stop (unillustrated) which adjusts the amount of light falling on the image sensor 2.

The image-sensing apparatus 1 is further provided with: an AFE (analog front end) 4 that converts the image signal—an analog signal—outputted from the image sensor 2 into a digital signal and that adjusts gain; a sound collection portion 5 that converts the sounds it collects into an electrical signal; an input-image processing portion 6 that converts the image signal—R (red), G (green), and B (blue) digital signals—outputted from the AFE 4 into a signal in terms of Y (luminance signal), U and V (color-difference signals), and that applies various kinds of image processing to the image signal; a sound processing portion 7 that converts the sound signal—an analog signal—outputted from the sound collection portion 5 into a digital signal; a compression processing portion 8 that applies compression/encoding processing for still images, as by a JPEG (Joint Photographic Experts Group) compression method, to the image signal outputted from the input-image processing portion 6, or that applies compression/encoding processing for moving images, as by an MPEG (Moving Picture Experts Group) compression method, to the image signal from the input-image processing portion 6 and the sound signal from the sound processing portion 7; an external memory 10 to which is recorded the compressed/encoded signal compressed/encoded by the compression processing portion 8; a driver portion 9 that records/reads out an image signal to/from the external memory 10; and a decompression processing portion 11 that decompresses and decodes a compressed/encoded signal read out from the external memory 10 in the driver portion 9.

The image-sensing apparatus 1 is further provided with: an output-image processing portion 12 that generates an image signal for display based on the image signal decoded by the decompression processing portion 11 and the image signal outputted from the input-image processing portion 6; a display-image output circuit portion 13 that converts the image signal outputted from the output-image processing portion 12 into a signal in a format displayable on a display device (unillustrated) such as a display; and a sound output circuit portion 14 that converts the sound signal decoded by the decompression processing portion 11 into a signal in a format reproducible on a reproducing device (unillustrated) such as a speaker.

The image-sensing apparatus 1 is further provided with: a CPU (central processing unit) 15 that controls the overall operation within the image-sensing apparatus 1; a memory 16 that stores programs for performing various kinds of processing and that temporarily stores signals during execution of programs; an operated portion 17 on which the user enters commands by use of buttons and the like such as those for starting shooting and for confirming various settings; a timing generator (TG) portion 18 that outputs a timing control signal for synchronizing the operation of different parts; a bus 19 across which signals are exchanged between the CPU 15 and different parts; and a bus 20 across which signals are exchanged between the memory 16 and different parts.

The external memory 10 may be any type so long as image signals and sound signals can be recorded to it. Usable as the external memory 10 is, for example, a semiconductor memory such as an SD (secure digital) card, an optical disc such as a DVD, or a magnetic disk such as a hard disk. The external memory 10 may be removable from the image-sensing apparatus 1.

Next, a description will be given of the basic operation of the image-sensing apparatus 1 with reference to FIG. 1. First, the image-sensing apparatus 1 acquires an image signal in the form of an electrical signal, by photoelectrically converting, in the image sensor 2, the light incoming through the lens portion 3. Then, in synchronism with the timing control signal fed from the TG 18, at a predetermined frame period (e.g., 1/30 seconds), the image sensor 2 sequentially outputs the image signal to the AFE 4. The image signal is converted from an analog signal to a digital signal by the AFE 4, and is then fed to the input-image processing portion 6. The input-image processing portion 6 converts the image signal into a signal in terms of YUV, and applies various kinds of image processing such as gradation correction and edge enhancement. The memory 15 acts as a frame memory, temporarily holding the image signal during the operation of the input-image processing portion 6.

Based on the image signal fed to the input-image processing portion 6 at this time, the lens portion 3 adjusts the position of different lenses for adjustment of focus, and also adjusts the aperture of the aperture stop for adjustment of exposure. In addition, based on the image signal fed, white balance is adjusted. The adjustment of focus, exposure, and white balance here is done automatically according to a predetermined program, or is done manually according to commands from the user.

When a moving image is recorded, an image signal along with a sound signal is recorded. The sound signal outputted from the sound collection portion 5—sounds as converted into an electrical signal by the sound collection portion 5—is fed to the sound processing portion 7, which then digitizes it and applies to it processing such as noise elimination. The image signal outputted from the input-image processing portion 6 and the sound signal outputted from the sound processing portion 7 are together fed to the compression processing portion 8, which then compresses them by a predetermined compression method. Here, the image signal and the sound signal are temporally associated with each other so that, at the time of playback, the image keeps pace with the sounds. The compressed image and sound signals are, via the driver portion 9, recorded to the external memory 10.

On the other hand, when a still image or sounds alone are recorded, either an image signal or sound signal is compressed by a predetermined compression method in the compression processing portion 8, and is then recorded to the external memory 10. The processing performed in the input-image processing portion 6 may be varied between when a moving image is recorded and when a still image is recorded.

On a command from the user, the compressed image and sound signals recoded to the external memory 10 are read out by the decompression processing portion 11. The decompression processing portion 11 decompresses the compressed image and sound signals. The decompressed image signal is fed to the output-image processing portion 12 to generate an image signal for display. The image signal outputted from the output-image processing portion 12 is fed to the display-image output circuit portion 13. On the other hand, the sound signal decompressed by the decompression processing portion 11 is fed to the sound output circuit portion 14. The display-image output circuit portion 13 and the sound output circuit portion 14 convert them into signals in formats displayable and reproducible on the display device and on the speaker respectively, and output these signals.

The display device and the speaker may be provided integrally with the image-sensing apparatus 1, or may be provided separately so as to be connected by cables or the like to terminals provided in the image-sensing apparatus 1.

At the time of so-called previewing, which enables the user to check the image displayed on the display device or the like without recording an image signal, the image signal outputted from the input-image processing portion 6 may be outputted, uncompressed, to the output-image processing portion 12. When the image signal of a moving image is recorded, at the same time that it is compressed by the compression processing portion 8 and recorded to the external memory 10, it may also be outputted, via the output-image processing portion 12 and the display-image output circuit portion 13, to the display device or the like.

The input-image processing portion 6 and the output-image processing portion 12 may be collectively regarded as one image processing portion (image processing apparatus), or one having parts of respective processing portions combined together may be regarded as one image processing portion (image processing apparatus).

### Output-Image Processing Portion

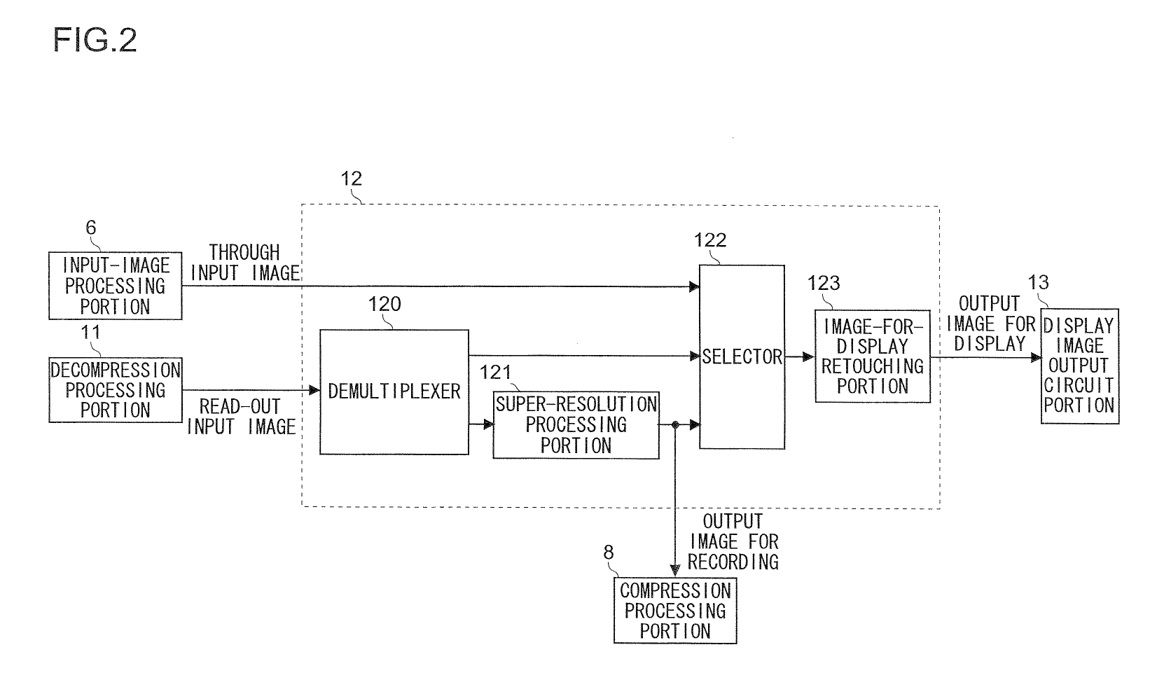

Next, a description will be given of the configuration of the output-image processing portion shown in FIG. 1 with reference to the relevant drawings. FIG. 2 is a block diagram showing a configuration of an output-image processing portion embodying the present invention. For the sake of concrete description, in the following description, the image signal fed to the output-image processing portion 12 is handled as images, called “input image”. Likewise, the image signal outputted from the output-image processing portion 12 is called an “output image”.

An input image directly fed from the input-image processing portion 6, via the bus 20, the memory 16, etc, to the output-image processing portion 12 at the time of previewing is particularly called a “through input image”. In addition, an input image that is first compressed by the compression processing portion 8 and recorded to the external memory 10, then read out by the decompression processing portion 11 to be decompressed, and then fed to the output-image processing portion 12 is particularly called a “read-out input image”. Furthermore, an output image that is first outputted from the output-image processing portion 12, then fed to the compression processing portion 8 to be compressed, and then recorded to the external memory 10 is particularly called an “output image for recording”. Moreover, an output image that is first outputted from the output-image processing portion 12, and is then fed to the display-image output circuit portion 13 to be displayed to the user is particularly called an “output image for display”.

As shown in FIG. 2, the output-image processing portion 12 is provided with: a demultiplexer 120 that properly selects the direction in which the fed read-out input image is outputted; a super-resolution processing portion 121 that applies super-resolution processing to the read-out input image outputted from the demultiplexer 120; a selector 122 that selects and outputs one from the through input image, the read-out input image outputted from the demultiplexer 120, and the image outputted from the super-resolution processing portion 121; and an image-for-display retouching portion 123 that retouches, so as to be displayable on the display device, the image outputted from the selector 122 and generates an output image for display. The super-resolution image outputted from the super-resolution processing portion 121 is outputted, as an output image for recording, from the output-image processing portion 12.

When a read-out input image to which super-resolution processing is applied is fed, the demultiplexer 120 feeds that read-out input image to the selector 122. On the other hand, when a read-out input image to which no super-resolution is applied is fed, the demultiplexer 120 feeds that read-out input image to the super-resolution processing portion 121.

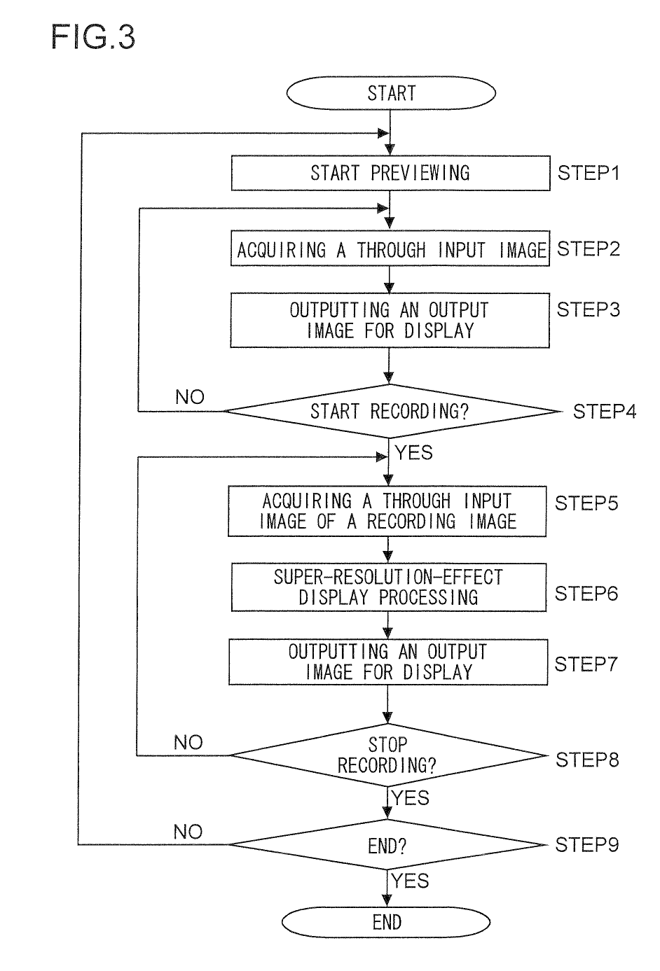

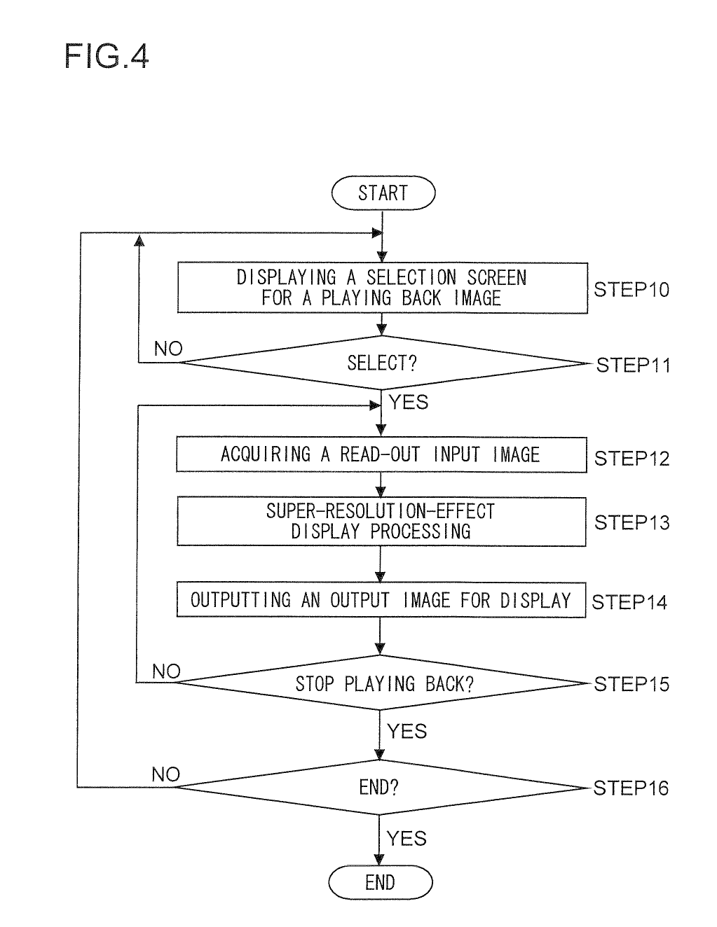

Next, a description will be given of the operation of the output-image processing portion 12 with reference to the relevant drawings. FIG. 3 is a flow chart showing an example of the operation of the output-image processing portion when super-resolution-effect display processing is performed at the time of image recording, and FIG. 4 is a flow chart showing an example of the operation of the output-image processing portion when super-resolution-effect display processing is performed at the time of image playback. The super-resolution-effect display processing is image processing performed to notify the user the effect (hereinafter referred to as the super-resolution effect) obtained when super-resolution processing is applied to an image, to which super-resolution processing is to be applied. Details of the super-resolution-effect display processing will be described later.

### At the Time of Image Recording

First, a description will be given of an example of operation when super-resolution-effect display processing is performed at the time of image recording. As shown in FIG. 3, before recording operation, previewing is performed for the user to determine the composition of an image to be recorded (STEP 1). When previewing starts, the output-image processing portion 12 acquires a through input image. At this time, the selector 122 operates such that the fed through input image is outputted to the image-for-display retouching portion 123.

The image-for-display retouching portion 123, to which the through input image is fed, generates to output an output image for display by performing resolution conversion suitable to the display capability of the display device (STEP 3). For example, when the display device is a compact one provided in an image-sensing apparatus and has a low display resolution with respect to the resolution of the through input image, resolution diminution processing (reduction processing) is performed on the through input image. The resolution diminution processing is processing whereby the number of pixels is reduced, for example, by performing pixel thinning-out or pixel addition.

Via the operated portion 17, whether or not the user has entered a command to record an image is checked (STEP 4). If no command to record an image is entered (“NO” at STEP 4), the flow returns to STEP 2 to continue with previewing, and a through input image is acquired.

Whereas if a command to record an image is entered (“YES” at STEP 4), image recording starts. Here, the output-image processing portion 12 acquires a through input image of the image to be recorded (hereinafter referred to as the recording image) (STEP 5). The recording image is an image that is outputted from the input-image processing portion 6, then fed to the compression processing portion 8 to be compressed, and then fed to the external memory 10 to be recorded. Here, the input-image processing portion 6 outputs the recording image to the compression processing portion 8, and in addition outputs the recording image (namely the through input image) also to the output-image processing portion 12.

The through input image acquired by the output-image processing portion 12 in STEP 5 is fed by the selector 122 to the image-for-display retouching portion 123. Then the image-for-display retouching portion 123 applies super-resolution-effect display processing to the through input image (STEP 6).

The image-for-display retouching portion 123 performs, other than super-resolution-effect display processing, processing such as resolution conversion to generate and output an output image for display (STEP 7). Then, the output image for display is outputted from the output-image processing portion 12 to be fed to the display-image output circuit portion 13, and is displayed thereafter by the display device as mentioned above.

Next, whether or not to stop recording is checked, based on, for example, whether or not the user has entered a command to stop image recording via the operated portion 17, whether or not a predetermined number of images has been recorded, etc. (STEP 8). If image recording is not to be stopped (“NO” at STEP 8), the flow returns to STEP 5 to continue with image recording, and a through input image of the next recording image is acquired.

Whereas if image recording is to be stopped (“YES” at STEP 8), subsequently, whether or not to end the operation of the image-sensing apparatus 1 is checked (STEP 9). If the operation of the image-sensing apparatus 1 is not to be ended (“NO” at STEP 9), the flow returns to STEP 1 to start previewing. Whereas if the operation of the image-sensing apparatus 1 is to be ended (“YES” at STEP 9), the operation ends.

With this configuration, it is possible to notify the user, at the time of image recording, the degree of effect of super-resolution processing. Thus, the user can easily judge whether or not to apply super-resolution processing to the recorded image.

Although super-resolution-effect display processing (STEP 6) is performed only when an image is recorded to the external memory 10 in this Practical Example, it is also possible, in addition (or instead), to perform super-resolution-effect display processing at the time of previewing (STEPS 1 through 3). In this case, between STEPS 2 and 3, super-resolution-effect display processing similar to that at STEP 6 is performed.

Moreover, the through input image that is fed at the time of previewing (STEPS 1 through 3) may be an image to which resolution diminution processing (for example, addition readout or thinning-out readout) has been applied at the time the image is read out from the image sensor 2. In this case, in the image-for-display retouching portion 123, resolution diminution processing may not be performed on the through input image.

Moreover, information indicating the super-resolution effect along with the image may be recorded to the external memory 10. For example, it may be written in a place (such as header information of an image file (or image data included in it); hereinafter simply referred to as header information etc.) to which the user can write.

### At the Time of Image Playback

Next, a description will be given of an example of operation when super-resolution-effect display processing is performed at the time of image playback. As shown in FIG. 4, before playback operation, an image to let the user to select an image to be played back is displayed (STEP 10). This is performed, for example, by acquiring, from the decompression processing portion 11, image information (e.g., thumbnail information) that has been recorded to the external memory 10, and by the image-for-display retouching portion 123 outputting, as an output image for display, an image having this information arranged in it. Note that an image that can be selected here is an image to which no super-resolution processing has been applied.

If the user does not select an image to be played back (“NO” at STEP 11), a selection screen at STEP 10 is continued to be displayed. Whereas if the user selects an image to be played back (“YES” at STEP 11), the output-image processing portion 12 acquires a read-out input image (STEP 12). Here, the demultiplexer 120 has a read-out input image to which no super-resolution is applied fed to it, and thus outputs this image to the super-resolution processing portion 121. Here, the super-resolution processing portion 121 outputs the read-out input image, without applying super-resolution to it, to the selector 122, which then outputs the fed read-out input image to the image-for-display retouching portion 123.

The image-for-display retouching portion 123 applies super-resolution-effect display processing to the fed read-out input image (STEP 13). In addition, the image-for-display retouching portion 123 generates to output an output image for display by performing, other than super-resolution-effect display processing at STEP 13, processing such as resolution conversion (STEP 14). Then, the output image for display is outputted from the output-image processing portion 12 to be fed to the display-image output circuit portion 13, and is displayed thereafter by the display device as mentioned above. Details of super-resolution-effect display processing will be described later.

When the output image for display is outputted at STEP 13, subsequently, whether or not to stop playback is checked, based on, for example, whether or not the user has entered, via the operated portion 17, a command to stop image playback (STEP 15). If image playback is not to be stopped (“NO” at STEP 15), the flow returns to STEP 12 to continue with image playback, and the next read-out input image is acquired.

Whereas if image playback is to be stopped (“YES” at STEP 15), subsequently, whether or not to end the operation of the image-sensing apparatus 1 is checked (STEP 16). If the operation of the image-sensing apparatus 1 is not to be ended (“NO” at STEP 16), the flow returns to STEP 10 and a selection screen for the playing-back image is displayed. Whereas if the operation of the image-sensing apparatus 1 is to be ended (“YES” at STEP 16), the operation ends.

With this configuration, it is possible to notify the user, at the time of image playback also, the degree of effect of super-resolution processing. Thus, the user can easily judge whether or not to apply super-resolution processing to an image that has been recorded.

This example deals with a case in which the read-out input image, to which super-resolution-effect display processing is applied, is displayed continuously, however, the read-out input image may be displayed as a still image. Moreover, corresponding to commands from the user, the output image for display may be switched sequentially with given timing. With this configuration, with respect to a scene or an image particularly important to the user, whether or not super-resolution processing is required can be checked closely.

Moreover, information indicating the super-resolution effect along with the image may be recorded to the external memory 10 at the time of image recording, and, by use of this information, super-resolution-effect display processing may be performed at the time of playback. For example, when information indicating the super-resolution effect can be obtained by referring to header information etc., with reference to the information, super-resolution-effect display processing may be performed.

### Super-Resolution Processing

At the time of image recording or image playback, the user checks an output image for display to which super-resolution-effect display processing is applied to consider whether or not super-resolution processing is required, and enters, via the operated portion 17, a command to execute super-resolution processing. For example, when a command to execute super-resolution processing is entered at the time of image recording, and an image to which super-resolution processing is executed is recorded to the external memory 10, the input-image processing portion 6 may perform super-resolution processing.

On the other hand, irrespective of the time at which a command to execute super-resolution processing is entered, when super-resolution processing is applied to the image recorded in the external memory 10, super-resolution processing is performed, for example, as described below. First, a read-out input image is fed to the demultiplexer 120 of the output-image processing portion 12. This read-out input image is an image to which no super-resolution is applied. Thus, the demultiplexer 120 feeds the read-out input image to the super-resolution processing portion 121. The super-resolution processing portion 121 applies super-resolution processing to the read-out input image to generate a super-resolution image. The super-resolution image so generated is fed to the compression processing portion 8 to be compressed, and is recorded to the external memory 10.

When the user enters a command to execute super-resolution processing on the image to which super-resolution processing has been applied, an error message or the like may be displayed. Moreover, the super-resolution processing portion 121 may perform super-resolution processing based on a plurality of images, and may be provided with a memory storing a plurality of images. Details of super-resolution processing will be described later.

Moreover, super-resolution images (those fed directly from the demultiplexer 120 to the selector 122, and those generated by being subjected to super-resolution processing by the super-resolution processing portion 121) may be displayable on the display device. In this case, a super-resolution image outputted from the selector 122 is converted, in the image-for-display retouching portion 123, into an image suitable for displaying. At the time of image playback, when no command to execute super-resolution processing is entered by the user, the super-resolution processing portion 121 outputs a read-out input image as is, i.e., without applying super-resolution processing to it, to the selector 122.

### Super-Resolution-Effect Display Processing

Next, super-resolution-effect display processing will be described by way of concrete examples thereof.

### Practical Example 1

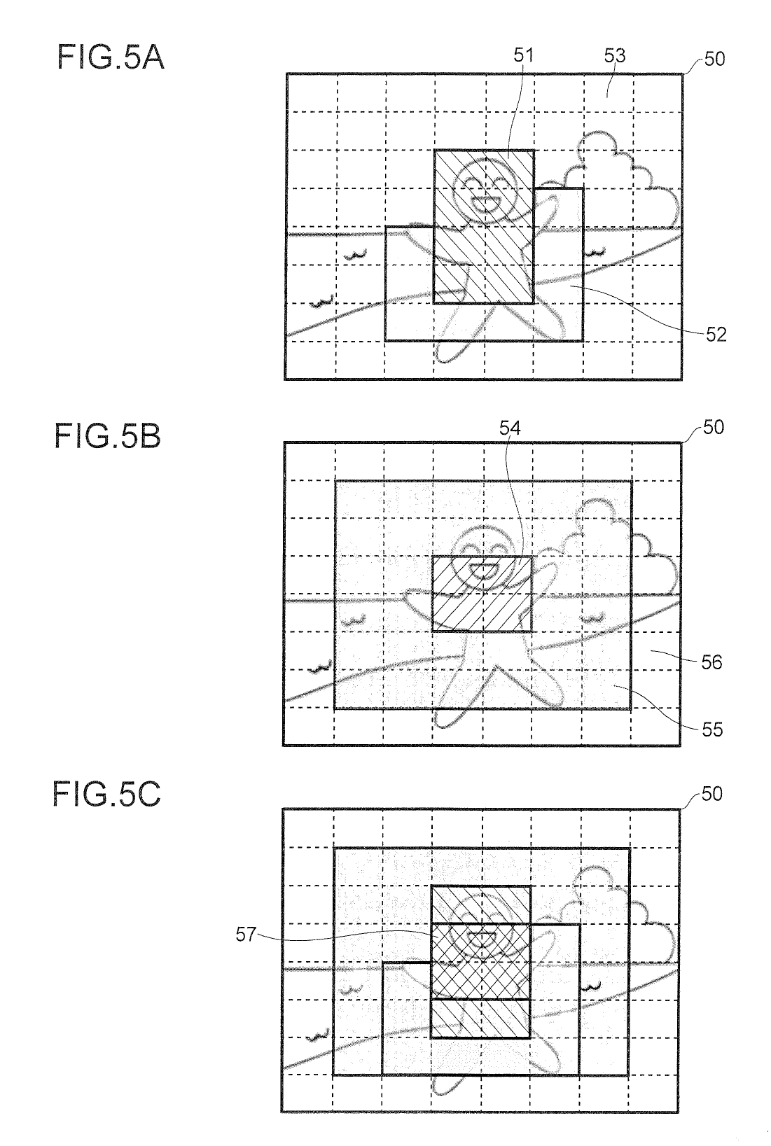

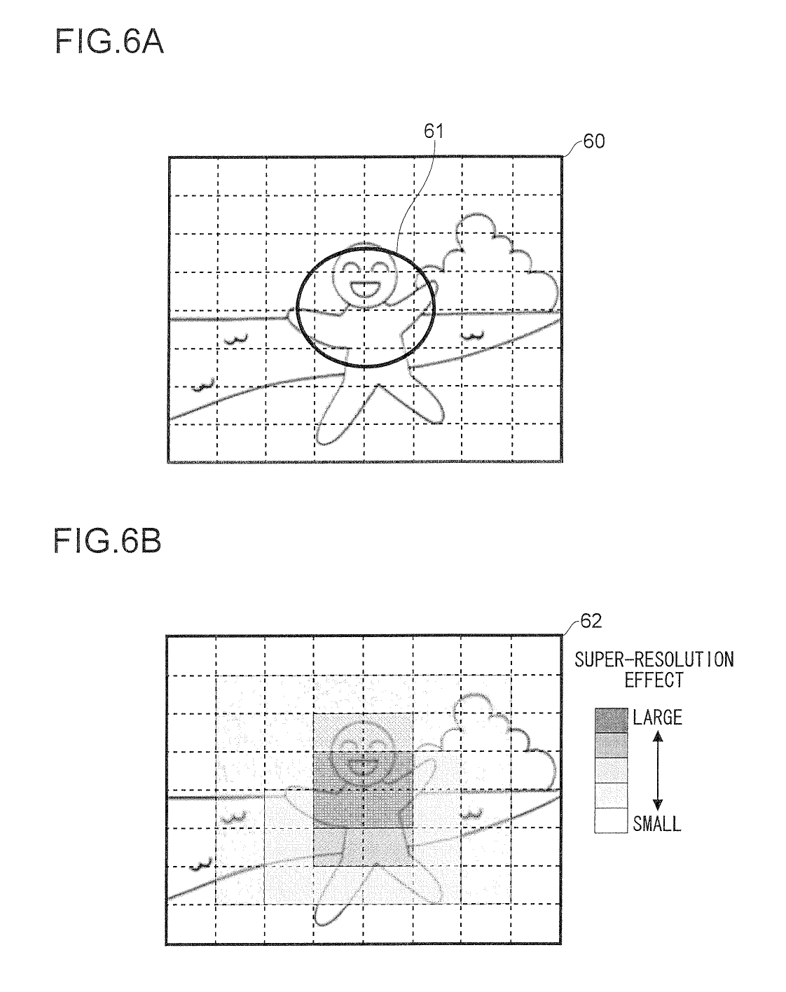

Practical Example 1 of super-resolution-effect display processing will be described with reference to the relevant drawings. FIGS. 5A to 5C are schematic views of an input image illustrating an example of calculating the super-resolution effect in Practical Example 1 of the super-resolution-effect display processing. FIGS. 6A and 6B are schematic views showing an example of an output image for display in Practical Example 1 of the super-resolution-effect display processing.

In this Practical Example, the image-for-display retouching portion 123 generates a super-resolution effect image based on super-resolution effect calculated for each location in an input image, and generates to output an output image for display containing this super-resolution effect image. Specifically, for example, the image-for-display retouching portion 123 generates a super-resolution effect image based on the degree of definition (e.g., contrast) of the input image. Note that, in an image, a region having a larger definition has a larger super-resolution effect, i.e., the degree of resolution enhancement is high.

Moreover, the input-image processing portion 6 may calculate the degree of definition for each location in the input image, and the image-for-display retouching portion 123 of the output-image processing portion 12 may acquire the result of this calculation, and may generate an output image for display.

For example, when this Practical Example is applied at the time of image recording, the image-for-display retouching portion 123 may acquire together a through input image and the result of calculating the definition from the input-image processing portion 6. On the other hand, when this Practical Example is applied at the time of image playback, the input-image processing portion 6 may calculate the definition at the time of image recording, and the result of this calculation and a recording image may be recorded in the external memory 10. In this case, the image-for-display retouching portion 123 acquires together a read-out input image and the result of calculating the definition at the time of image playback.

In this Practical Example, as one evaluation value for calculating the definition of an input image, an AF (auto-focus) evaluation value may be used. The AF evaluation value is calculated, for example, by use of high-frequency components of the luminance value of the input image. The AF evaluation value can be calculated, particularly by dividing the input image into predetermined blocks (for example, dividing into 8×8=64 blocks) and adding up high-frequency components of the luminance value in every block. Note that at the time of image recording, the input-image processing portion 6 calculates the AF evaluation value and controls focusing of the lens portion 3. Thus, if the image-for-display retouching portion 123 acquires the AF evaluation value calculated at the time of image recording and utilizes it, the amount of calculation can be reduced, which is preferable.

FIG. 5A is a schematic view of an input image showing a concrete example of the result of calculating the AF evaluation value. FIG. 5A shows, in an input image 50 targeted by calculation, a focus region 51 which is a region including a block having a large AF evaluation value, a non-focus region 53 which is a region including a block having a small AF evaluation value, and an intermediate region 52 which is a region including a block having an AF evaluation value intermediate between those of the focus region 51 and the non-focus region 53. Note that FIG. 5A shows a case where a center part of the input image 50 is the focus region 51 and a peripheral part of the input image 50 is the non-focus region 53.

In this Practical Example, as one evaluation value for calculating the definition of an input image, a lens-characteristics evaluation value may be used. The lens-characteristic evaluation value is a value calculated by use of a lens MTF (modulation transfer function), and is an evaluation value determined by the characteristics of the lens used in the image-sensing apparatus 1. Thus, regardless of the image targeted by calculation, the lens-characteristics evaluation value is an invariable evaluation value that can be set previously. In addition, like the AF evaluation value, the lens-characteristics evaluation value can be, for example, a value at every block.

FIG. 5B is a schematic drawing of an input image showing a concrete example of the lens-characteristic evaluation value; particularly, one set by use of the lens MTF. FIG. 5B shows a case where a center part of an input image 50 is a large region 54 in which the lens-characteristics evaluation value is large, where a peripheral part of the input image 50 is a small region 56 in which the lens-characteristics evaluation value is small, and where a region intermediate between those is an intermediate region 55 having a lens-characteristics evaluation value intermediate between those of the large region 54 and the small region 56.

A case where the degree of super-resolution effect is calculated by use of the AF evaluation value and the lens-characteristics evaluation value described above is shown in FIG. 5C. FIG. 5C is a schematic view of an input image displayed by combining together the AF evaluation value shown in FIG. 5A and the lens-characteristics evaluation value shown in FIG. 5B. As shown in FIG. 5C, a region where the focus region 51 of the AF evaluation value overlaps the large region 54 of the lens-characteristics evaluation value is a region 57 where the super-resolution effect is particularly large. Note that FIG. 5C shows a case where a center part of the input image 50 is the region 57 in which the super-resolution effect is large, and where the super-resolution effect is smaller towards a peripheral part of the image 50.

FIGS. 6A and 6B show examples of an output image for display generated for notifying the user the degree of super-resolution effect as shown in FIG. 5C. FIGS. 6A and 6B both show examples based on the result of calculating the super-resolution effect shown in FIG. 5C.

An output image 60 for display shown in FIG. 6A has an emphasizing mark 61—a super-resolution effect image—added to a region (the region 57 in FIG. 5C) where the super-resolution effect is particularly large within the input image. Note that, although the emphasizing mark 61 is expressed by an ellipse in FIG. 6A, it may be expressed by a rectangle. Moreover, the emphasizing mark 61 may indicate not only a region where the super-resolution effect is particularly large, but also the entire region where the super-resolution effect is large.

An output image 61 for display shown in FIG. 6B is an input image having a super-resolution effect image—an image that is color-coded according to the degree of super-resolution effect—added to it. Note that, in FIG. 6B, there is shown a case where an image which is color-coded in gray scale is added, however, an image which is color-coded in color may be added.

Thus, a super-resolution effect image corresponding to the location in an image based on the definition of the image is contained in an output image for display, and this makes it possible for the user to check whether or not the super-resolution effect in a desired region is large. Moreover, the degree of super-resolution effect is expressed objectively, and thus the degree of super-resolution effect is recognized easily. Accordingly, the user can easily judge whether or not super-resolution processing is required.

In the examples shown in FIGS. 5A to 5C and FIGS. 6A and 6B, a super-resolution image is generated by calculating the degree of super-resolution effect in each block, however, the calculation may be performed in each pixel.

### Practical Example 2

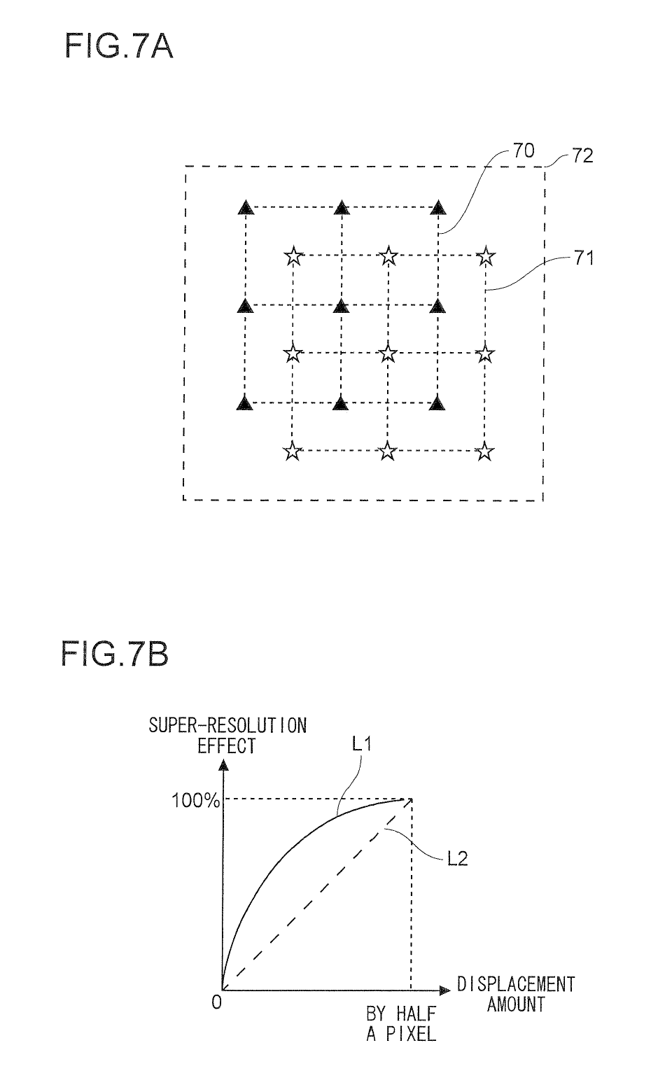

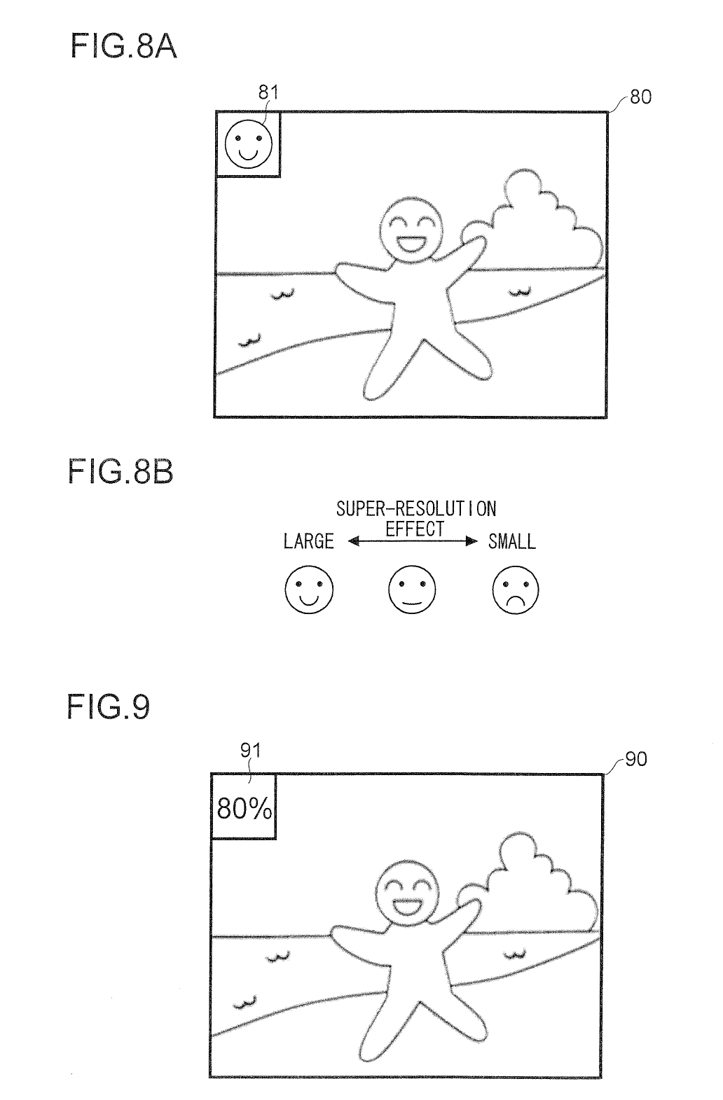

Practical Example 2 of super-resolution-effect display processing will be described with reference to the relevant drawings. FIGS. 7A and 7B are diagrams showing the relationship between an input image and the super-resolution effect. FIGS. 8A and 8B are schematic drawings showing an example of an output image for display in Practical Example 2 of super-resolution-effect display processing. FIG. 9 is a schematic drawing showing another example of an output image for display in Practical Example 2 of super-resolution-effect display processing.

In this Practical Example, the image-for-display retouching portion 123 calculates the positional relationship among a plurality of input images to calculate the super-resolution effect, and generates a super-resolution effect image based on the result of this calculation. Then, the image-for-display retouching portion 123 generates to output an output image for display containing this super-resolution effect image. Specifically, based on the positional relationship among the input images having undergone the position adjustment (displacement correction) to merge them together, the super-resolution effect is calculated. For example, the super-resolution effect is calculated by use of displacement amount, which is the distance of displacement.

The output image for display can also be generated by the input-image processing portion 6 calculating the displacement amount of a plurality of input images, and the image-for-display retouching portion 123 of the output-image processing portion 12 acquiring the result of this calculation.

For example, when this Practical Example is applied at the time of image recording, the image-for-display retouching portion 123 may acquire together a through input image and the result of calculating the displacement amount from the input-image processing portion 6. On the other hand, when this Practical Example is applied at the time of image playback, the input-image processing portion 6 calculates the displacement amount at the time of image recording, and the result of this calculation and a recording image may be recorded to the external memory 10. In this case, the image-for-display retouching portion 123 acquires together a read-out input image and the result of calculating the displacement amount at the time of image playback.

When super-resolution processing is performed by use of a plurality of input images as described later, when using two input images in particular, the optimal (where the degree of resolution enhancement is high) displacement amount is, for example, by half a pixel of an input image.

A case where the distance of the displacement amount is by half a pixel is shown in FIG. 7A. In FIG. 7A, a position of a subject 72 indicated by individual pixels of one input image (a first image) 70 for comparison is indicated by solid black triangles, and a position of the subject 72 indicated by individual pixels of another input image (a second image) 71 is indicated by white stars. As shown in FIG. 7A, the case where the distance of the displacement amount is by half a pixel is a case where the individual pixels of the second image 71 indicate individual positions of the subject 72, which are midpoint positions between horizontally adjacent pixels and midpoint positions between vertically adjacent pixels of the first image 70.

Super-resolution processing described later is one that performs resolution enhancement by merging together pixels of a plurality of input images. Thus, when the position of the subject 72 indicated by the pixels of each image is displaced to midpoint positions (i.e., displaced such that the displace amount is the maximum) as shown in FIG. 7A, it can be assumed that the super-resolution effect is large.

For calculation of the displacement amount, representative matching described later can be used. It is also possible to use block matching, a gradient method, or the like. It should be noted, however, that a calculation method having so-called sub-pixel resolution—resolution higher than the pixel spacing of an image is to be used. For example, there may be used a method disclosed in JP-A-11-345315, or a method described in “Okutomi, “Digital Image Processing”, second edition, CG-ARTS society, published on Mar. 1, 2007” (see page 205).

The displacement amount is calculated by averaging, in the entire image, the displacement amount calculated in each pixel. The displacement amount may also be calculated by averaging, in the entire image, the displacement amount calculated in each block.

For example, super-resolution effect is assumed to be 100% when the distance of the displacement amount is by half a pixel, and is assumed to be 0% when the distance is by zero pixel. Note that the super-resolution effect may be regarded as being fluctuated linearly or nonlinearly to the displacement amount. When the super-resolution effect is regarded as being fluctuated linearly, the super-resolution effect when the displacement amount is larger than by zero pixel but smaller than by half a pixel may be calculated by linearly interpolating values of the super-resolution effect when displaced by zero pixel and when displaced by half a pixel. On the other hand, when the super-resolution effect is regarded as being fluctuated nonlinearly, the super-resolution effect when the displacement amount is larger than by zero pixel but smaller than by half a pixel may be calculated, for example, using an interpolation curve L1 shown in FIG. 7B. Note that the super-resolution effect—obtained from the interpolation curve L1 shown in FIG. 7B—when the displacement amount is larger than by zero pixel but smaller than by half a pixel, has a value larger than the super-resolution effect—obtained from an interpolation curve L2—when linear interpolation is performed.

Next, a description will be given of a concrete example of an output image for display. An output image 80 for display shown in FIG. 8A has a face 81—the super-resolution effect image—of a character added to an input image. The face 81 of the character may be made, for example, happier (more smiley) as the super-resolution effect increases as shown in FIG. 8B.

Like an output image 90 for display shown in FIG. 9, an image 91—the super-resolution effect image—indicating the value of the super-resolution effect may be added to an input image.

As described above, the super-resolution effect image that indicates the super-resolution effect on the entire image based on the displacement amount of the image is contained in an output image for display; this makes it possible for the user to quickly check whether or not the super-resolution effect is large. Moreover, since the degree of super-resolution effect is expressed objectively, the degree of super-resolution effect is recognized easily. Accordingly, the user can easily judge whether or not super-resolution processing is required.

Although, as an example, the displacement amounts of two input images are calculated, and the super-resolution effect is assumed to be the maximum when the displacement amount is by half a pixel, this Practical Example is not limited to this example. For example, the positional relationship between three or more input images may be calculated. In this case, for example, the displacement amounts of two input images may be calculated sequentially and, by use of these displacement amounts (for example, by use of the total sum), the super-resolution effect may be calculated, or the super-resolution effect may be calculated by use of a polygonal area formed by corresponding pixels (for example, pixels that are displaced but are close to one another) of a plurality of input images. Furthermore, the super-resolution effect may be assumed to be large when these displacement amounts or the area are/is large. Moreover, the positional relationship may be calculated by use of the same number of input images as those used in super-resolution processing.

Moreover, as in Practical Example 1, the super-resolution effect may be calculated in each location (for example, in each block) within an image to generate the super-resolution effect image. Moreover, when the super-resolution effect of a moving image is calculated, the super-resolution effect in each image (or block) may be calculated by weighted averaging for a plurality of images (or for a predetermined period) or for one moving image file. Moreover, the calculation may be performed in combination with Practical Example 1. For example, the super-resolution effect calculated in Practical Example 1 and the super-resolution effect calculated in Practical Example 2 may be weighted and merged together to calculate the super-resolution effect.

### Practical Example 3

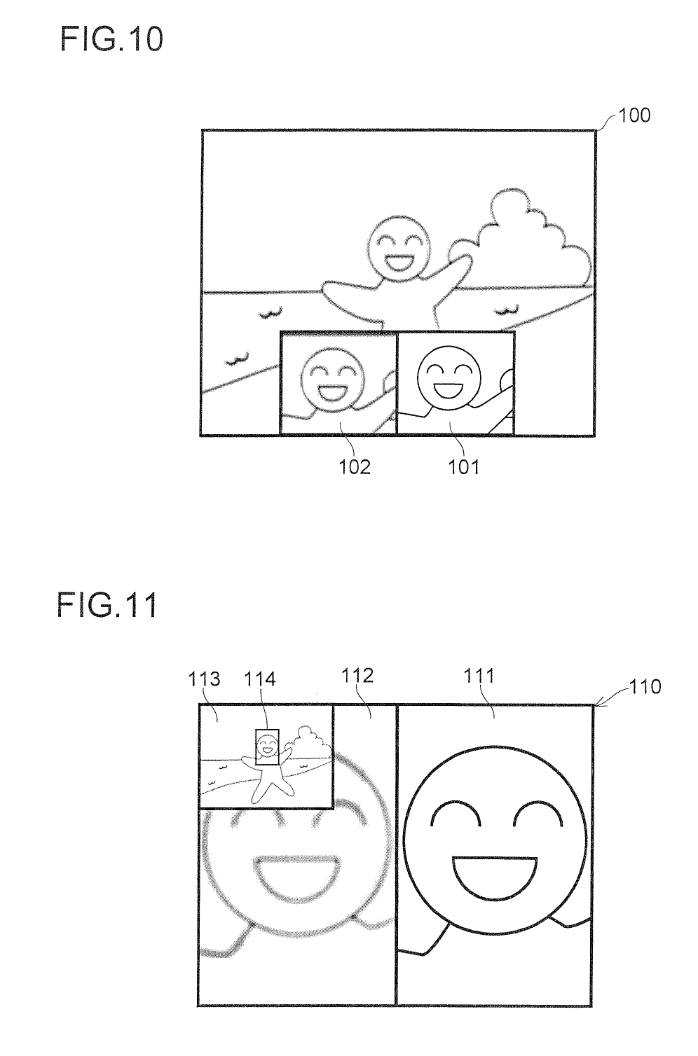

Practical Example 3 of super-resolution-effect display processing will be described with reference to the relevant drawings. FIG. 10 is a schematic view showing an example of an output image for display in Practical Example 3 of super-resolution-effect display processing. FIG. 11 is a schematic view showing another example of the output image for display in Practical Example 3 of the super-resolution-effect display processing.

As shown in FIG. 10, in this Practical Example, a local super-resolution image 101 is used in which local super-resolution processing is applied only to a region (hereinafter referred to as the target region), in an input image, where super-resolution effect is judged to be large. Specifically, the image-for-display retouching portion 123 generates an output image 100 for display by use of a local input image 102—an image indicating the target region in an input image—and a local super-resolution image 101. Note that an image having the local super-resolution image 101 and the local input image 102 combined together is the super-resolution effect image.

For example, the image-for-display retouching portion 123 overlays the local super-resolution image 101 and the local input image 102, with them adjacent to each other, on an input image. The image-for-display retouching portion 123 prevents overlapping of a region, on which the local super-resolution image 101 and the local input image 102 are overlaid, and the target region of the output image 100 for display.

Generating and displaying an output image 100 for display as described above makes it possible to compare the local super-resolution image 101 and the local input image 102 easily, since they are displayed with them adjacent to each other. Moreover, since the local super-resolution image 101 and the local input image 102 are displayed such that they are not overlaid on the target region of the output image 100 for display, the user can easily recognize the location of the target region and the image around the target region.

The output image for display may also be, for example, an output image 110 for display as shown in FIG. 11. In the output image 110 for display in FIG. 11, a local super-resolution image 111 and a local input image 112 are larger than those shown in FIG. 10. Specifically, the local super-resolution image 111 and the local input image 112 are larger than the target region in the case where the entire input image is made to be the output image for display.

For example, as mentioned earlier, when reduction processing is applied to an input image so as to make it adapt to the display resolution of the display device in the image-sensing apparatus 1, the image-for-display retouching portion 123 generates an output image 110 for display by use of a local super-resolution image 111 and a local input image 112, both to which no reduction processing is applied. Alternatively, an output image 110 for display is generated by use of a local super-resolution image 111 and a local input image 112, both obtained by performing reduction processing at a reduction factor larger than that (an image having undergone reduction/a source image) in the case where the entire input image is made to be the output image for display.

As in FIG. 10, also in the output image 110 for display in FIG. 11, the local super-resolution image 111 and the local input image 112 are made to be adjacent to each other. In addition, on a predetermined region (in FIG. 11, a region at the above left) in a peripheral part of the local input image 112, a reduced input image 113—an image in which the entire input image is reduced—is overlaid. The reduced input image 113 is, for example, an image on which reduction processing is performed at a reduction factor smaller than that in the case where the entire input image is made to be the output image for display. Note that making the size of the reduced input image 113 such that it can be placed within the local input image 112 helps the local super-resolution image 111 to be recognized more easily, which is preferable.

Furthermore, to a region corresponding to the target region in the reduced input image 113, an emphasizing mark 114 is added. As shown in FIG. 11, for example, a rectangle enclosing the target region is added to the reduced input image 113.

By generating and displaying an output image 110 for display as described above, since the local super-resolution image 111 and the local input image 112 are displayed with them adjacent to each other, these images can be compared easily. Moreover, the local super-resolution image 111 and the local input image 112 are displayed larger compared with those in FIG. 10, and thus the super-resolution effect can be checked more easily. Furthermore, since the reduced input image 113 and the rectangle 114 are displayed, it is possible for the user to recognize the location of the target region and the image around the target region easily.

As described above, by displaying with super-resolution processing applied only to the target region—which is a local region—where the super-resolution effect is large, the user can check the super-resolution effect directly and efficiently. Thus, it is possible to easily determine whether or not super-resolution processing is required. In addition, the region to which super-resolution processing is applied is limited to a local region. Thus, compared with when super-resolution processing is applied to the entire input image, it is possible to reduce processing time and power consumption.

As a method for determining the target region—a region in which the super-resolution effect is large—, methods described in Practical Examples 1 and 2 may be used. This Practical Example is preferably performed before an output image for recording is generated by the super-resolution processing portion 121. Particularly after an output image for display of Practical Example 1 or 2 is displayed and the user has determined to perform super-resolution processing, this Practical Example may be performed to allow the user to check definitively. Moreover, the local super-resolution image may be generated, for example, by the super-resolution processing 121. In this case, the through input image may be fed to the super-resolution processing portion 121. Further more, the super-resolution processing portion 121 may output together the local super-resolution image and the input image.

### Modified Example

Practical Examples 1 to 3 described above may be executed in combination. For example, Practical Example 1 may be executed at the time of image recording, then Practical Example 2 may be executed at the time of image playback after image recording, and then Practical Example 3 may be executed just before super-resolution processing. Moreover, for example, there may be generated an output image for display in which super-resolution effect images generated by executing Practical Examples 1 to 3 are displayed at the same time.

### Super Resolution Processing

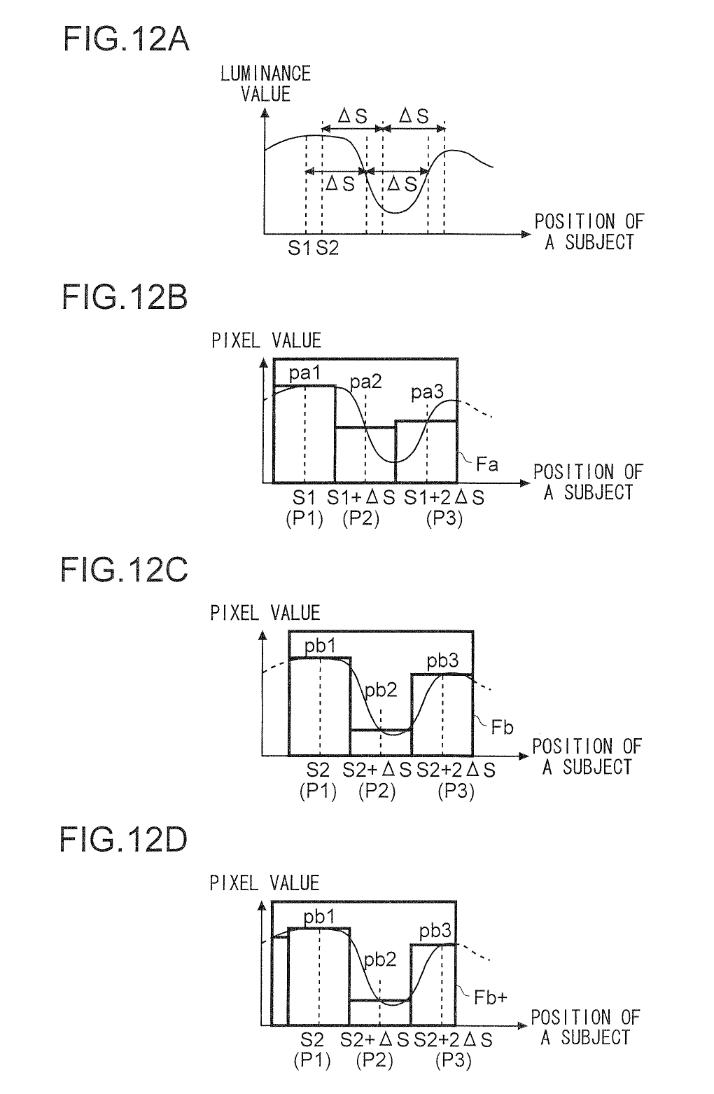

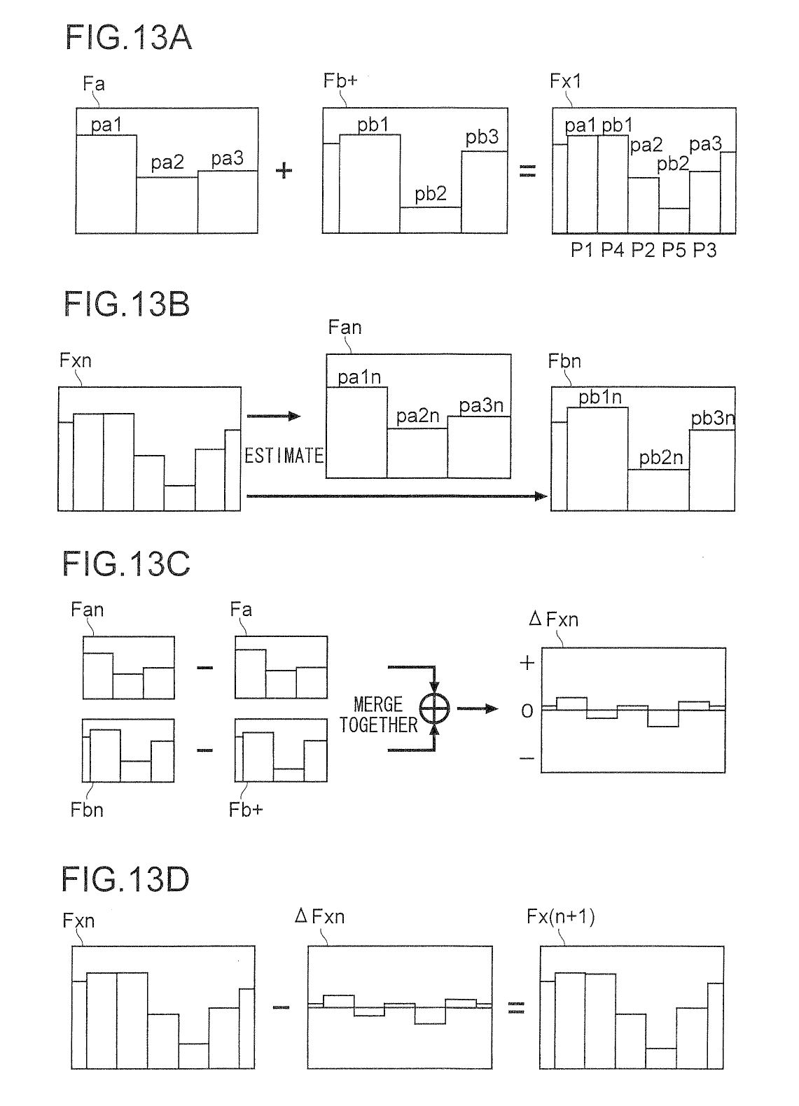

As the super-resolution processing described above, any existing method may be used; a case where a MAP (maximum a posterior) method, which is one kind of super-resolution processing, is used will be taken up as an example below for description with reference to the relevant drawings. FIGS. 12 and 13 are diagrams showing an outline of an example of generation of a super-resolution image. Although this example deals with super-resolution processing in which iteration can be executed, it is possible to apply to the invention a method of super-resolution processing in which no iteration is performed.

In the following description, for the sake of simple description, considered will be a plurality of pixels arrayed in one given direction in an input image. The example described below takes up a case where two input images are merged together to generate a super-resolution image and where values of pixels to be merged are luminance values.

FIG. 12A is a graph showing the luminance distribution of a subject to be shot. FIGS. 12B and 12C each show the luminance distribution of an input image obtained from an input image acquired by shooting the subject shown in FIG. 12A. FIG. 12D shows an image obtained by shifting the input image shown in FIG. 12C by a predetermined amount. Note that the input image (hereinafter referred to as the actual low-resolution image Fa) shown in FIG. 12B and the input image (hereinafter referred to as the actual low-resolution image Fb) shown in FIG. 12C are shot at time points apart from each other.

As shown in FIG. 12B, let the positions of sample points in an actual low-resolution image Fa obtained by shooting the subject having the luminance distribution shown in FIG. 12A at time point T1 be S1, S1+ΔS, and S1+2ΔS. On the other hand, as shown in FIG. 12C, let the positions of sample points in an actual low-resolution image Fb obtained by shooting at time point T2 (T1≠T2) be S2, S2+ΔS, and S2+2ΔS. It is assumed here that a sample point S1 in the actual low-resolution image Fa and a sample point S2 in the actual low-resolution image Fb are displaced from each other due to camera shake or the like. That is, pixel positions are displaced by (S1−S2).

In the actual low-resolution image Fa shown in FIG. 12B, the luminance values obtained at the sample points S1, S1+ΔS, and S1+2ΔS become pixel values pa1, pa2, and pa3 at pixels P1, P2, and P3. Likewise, in the actual low-resolution image Fb shown in FIG. 12C, the luminance values obtained at the sample points S2, S2+ΔS, and S2+2ΔS become pixel values pb1, pb2, and pb3 at pixels P1, P2, and P3.

Here, when the actual low-resolution image Fb is expressed by taking the pixels P1, P2, and P3 in the actual low-resolution image Fa as the reference (a pixel of interest) (i.e., when the displacement of the actual low-resolution image Fb is corrected by the displacement amount (S1−S2) relative to the actual low-resolution image Fa), the displacement-corrected actual low-resolution image Fb+ is as shown in FIG. 12D.

FIG. 13 shows a method for generating a high-resolution image by combining together the actual low-resolution image Fa and the actual low-resolution image Fb+. First, as shown in FIG. 13A, the actual low-resolution image Fa and the actual low-resolution image Fb+ are combined together to estimate a high-resolution image Fx1. For the sake of simple description, it is assumed that, for example, the resolution is going to be doubled in one given direction. Specifically, the pixels of the high-resolution image Fx1 will include the pixels P1, P2, and P3 of the actual low-resolution images Fa and Fb+, a pixel P4 located halfway between the pixels P1 and P2, and a pixel P5 located halfway between the pixels P2 and P3.

Selected as the pixel value at the pixel P4 of the high-resolution image Fx1 is a pixel value pb1, because the distance from the pixel position of the pixel P1 in the actual low-resolution image Fb+ to that of the pixel P4 is shorter than the distances from the pixel positions (the center positions) of the pixels P1 and P2 in the actual low-resolution image Fa to the pixel position of the pixel P4. Likewise, selected as the pixel value of the pixel P5 is a pixel value pb2, because the distance from the pixel position of the pixel P2 in the actual low-resolution image Fb+ to that of the pixel P5 is shorter than the distances from the pixel positions of the pixels P2 and P3 in the actual low-resolution image Fa to the pixel position of the pixel P5.

Thereafter, as shown in FIG. 13B, the high-resolution image Fx1 thus obtained is subjected to calculation according to conversion formula including, as parameters, the amount of down sampling, the amount of blur, the amount of displacement, etc., thereby to generate estimated low-resolution images Fa1 and Fb1, which are estimated images corresponding to the actual low-resolution images Fa and Fb respectively. Note that in FIG. 13B, there are shown estimated low-resolution images Fan and Fbn, which are generated from a high-resolution image Fxn estimated through the processing performed for the nth time.

For example, when n=1, based on the high-resolution image Fx1 shown in FIG. 13A, the pixel values at the sample points S1, S1+ΔS, and S1+2ΔS are estimated, and an estimated low-resolution image Fa1 is generated that has the thus acquired pixel values pa11 to pa31 as the pixel values at the pixels P1 to P3. Likewise, based on the high-resolution image Fx1, the pixel values at the sample points S2, S2+ΔS, and S2+2ΔS are estimated, and an estimated low-resolution image Fb1 is generated that has the thus acquired pixel values pb11 to pb31 as the pixel values at the pixels P1 to P3. Then, as shown in FIG. 13C, the differences between each of the estimated low-resolution images Fa1 and Fb1 and the corresponding one of the actual low-resolution images Fa and Fb are calculated, and these differences are merged together to acquire a differential image AFx1 with respect to the high-resolution image Fx1. Note that in FIG. 13C, there is shown a differential image ΔFxn with respect to the high-resolution image Fxn acquired through the processing performed for the nth time.

For example, a differential image AFal has, as the pixel values of P1 to P3, the difference values (pa11−pa1), (pa21−pa2), and (pa31−pa3), and a differential image ΔFb1 has, as the pixel values of P1 to P3, the difference values (pb11−pb1), (pb21−pb2), and (pb31−pb3). Then, by merging together the pixel values of the differential images ΔFa1 and ΔFb1, difference values at the pixels P1 to P5 respectively are calculated, thereby to acquire the differential image ΔFx1 with respect to the high-resolution image Fx1. When the differential image ΔFx1 is acquired by merging together the pixel values of the differential images ΔFa1 and ΔFb1, for example, in cases where an ML (maximum likelihood) method or a MAP method is used, square errors are used as an evaluation function. Specifically, values which are frame-to frame sums of squared pixel values between the differential images ΔFa1 and ΔFb1 are used as the evaluation function. The gradient, which is the value of the derivative of this evaluation function, has values twice as great as the pixel values of each of the differential images ΔFa1 and ΔFb1. Accordingly, the differential image ΔFx1 with respect to the high-resolution image Fx1 is calculated through resolution enhancement using values twice as great as the pixel values of each of the differential images ΔFa1 and ΔFb1.

Thereafter, as shown in FIG. 13D, the pixel values (difference values) at the pixels P1 to P5 in the thus obtained differential image ΔFx1 are subtracted from the pixel values at the pixels P1 to P5 in the high-resolution image Fx1, and thereby a high-resolution image Fx2 is reconstructed that has pixel values close to the subject having the luminance distribution shown in FIG. 12A. Note that in FIG. 13D, there is shown a high-resolution image Fx (n+1) obtained through the processing performed for the nth time.

The sequence of processing described above is repeated so that, as the pixel values of the differential image ΔFxn thus obtained grow smaller, the pixel values of the high-resolution image Fxn converge to the pixel values close to the subject having the luminance distribution shown in FIG. 12A. Then, when the pixel values (difference values) of the differential image ΔFxn become smaller than a predetermined value, or when the pixel values (difference values) of the differential image ΔFxn have converged, the high-resolution image Fxn obtained through the previous processing (performed for the n−1th time) is, for example, outputted from the super-resolution processing portion 121 as a super-resolution image.

### Representative Matching

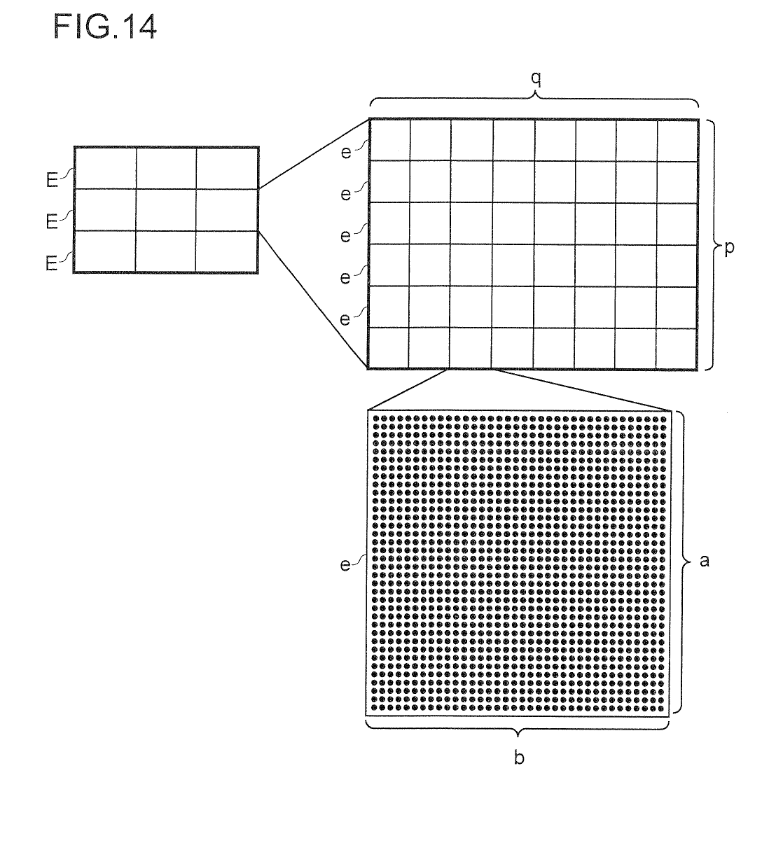

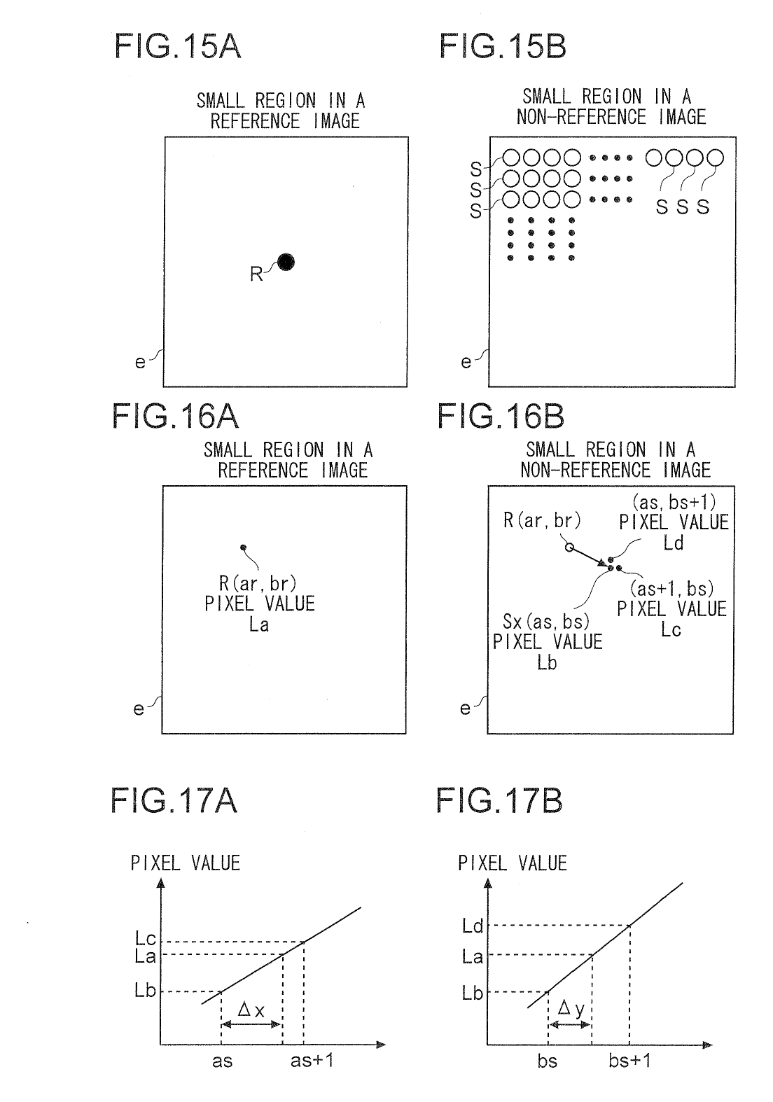

In Practical Example 2 of super-resolution-effect display processing or in super-resolution processing described above, at the time of calculating the displacement amount, it is possible to use, for example, representative matching and single-pixel displacement amount detection as described below. First, representative matching, and then single-pixel displacement amount detection, will be described with reference to the relevant drawings. FIGS. 14 and 15 are diagrams showing representative matching. FIG. 14 is a diagram schematically showing how an image is divided into regions; FIG. 15 is a diagram schematically showing a reference image and a non-reference image.

In representative matching, for example, an image serving as a reference (reference image) and an image compared with the reference image to detect movement (non-reference image) are each divided into regions as shown in FIG. 14. For example, an image is first divided into a plurality of detection regions E, of which each is then further divided into p×q (e.g., 6×8) small regions e, of which each is composed of a group of a×b (e.g., 36×36) pixels. Moreover, as shown in FIG. 15A, one of the a×b pixels composing a small region e is set as a representative point R. On the other hand, as shown in FIG. 15B, a plurality of the a×b pixels composing a small region e are set as sampling points S (e.g., all the a×b pixels may be set as sampling points S).

With the small regions e and the detection regions E set as described above, between the small regions e at the same position in the reference and non-reference images, the difference of the pixel value at each sampling point S in the non-reference image from the pixel value of the representative point R in the reference image is calculated as the correlation value at that sampling point S. Then, for each detection region E, the correlation value at any sampling point S whose position relative to the representative point R is the same among different small regions e is cumulatively added with respect to all the small regions e composing the detection region E, and thereby the cumulative correlation value at each sampling point S is acquired. In this way, for each detection region E, the correlation values at the p×q sampling points S whose position relative to the representative point R is the same are cumulatively added, so that as many cumulative correlation values as there are sampling points S are obtained (e.g., when all the a×b pixels are set as sampling points S, a×b cumulative correlation values are obtained).

After, for each detection region E, the cumulative correlation values at individual sampling points S have been calculated, then, for each detection region E, the sampling point S considered to have the highest correlation with the representative point R (i.e., the sampling point S with the least cumulative correlation value) is detected. Then, for each detection region E, the displacement amount of the sampling point S with the least cumulative correlation value and of the representative point R are calculated based on their respective pixel positions. Thereafter, the displacement amounts calculated for the individual detection regions E are averaged so that the average value is detected as the displacement amount, given in the unit of pixels, between the reference and non-reference images.

### Single-Pixel Displacement Amount Detection

Next, single-pixel displacement amount detection will be described with reference to the relevant drawings. FIG. 16 is a schematic view of a reference image and a non-reference image illustrating single-pixel displacement amount detection, and FIG. 17 is a graph showing the relationship among the pixel values of representative and sampling points during single-pixel displacement amount detection.

After the amounts of displacement in the unit of pixels have been detected by use of, for example, representative matching or the like as described above, the amounts of displacement within a single pixel can additionally be detected by the method described below. For example, for each small region e, the amount of displacement within a single pixel can be detected based on the relationship among the pixel value of the pixel at the representative point R in the reference image and the pixel values of the pixel at, and pixels around, a sampling point Sx with a high correlation with the representative point R.

As shown in FIG. 16, for each small region e, based on the relationship among: a pixel value La of the representative point R at pixel position (ar, br) in the reference image; a pixel value Lb of a sample point Sx at pixel position (as, bs) in the non-reference image; a pixel value Lc at pixel position (as+1, bs) horizontally adjacent to the sample point Sx; and a pixel value Ld at pixel position (as, bs+1) vertically adjacent to the sample point Sx, the amount of displacement within a single pixel is detected. Here, by representative matching, the amount of displacement in the unit of pixels from the reference image to the non-reference image is calculated as a value expressed by a vector quantity (as−ar, bs−br).

It is assumed that, as shown in FIG. 17A, deviating one pixel horizontally from the pixel taken as the sample point Sx brings a linear change from the pixel value Lb to the pixel value Lc. Likewise, it is also assumed that, as shown in FIG. 17B, deviating one pixel vertically from the pixel taken as the sample point Sx brings a linear change from the pixel value Lb to the pixel value Ld. Then, the horizontal position Δx (=(La−Lb)/(Lc−Lb)) between the pixel values Lb and Lc at which the pixel value is La, and the vertical position Δy (=(La−Lb)/(Ld−Lb)) between the pixel values Lb and Ld at which the pixel value is La, are calculated. That is, a vector quantity expressed by (Δx, Δy) is calculated as the amount of displacement within a single pixel, between the reference and non-reference pixels.

In this way, the amount of displacement within a single pixel in each small regions e is calculated. Then, the average value obtained by averaging the amount of displacement thus calculated is detected as the amount of displacement within a single pixel between the reference image (e.g., the actual low-resolution image Fb) and the non-reference image (e.g., the actual low-resolution image Fa). Then, by adding the thus calculated amount of displacement within a single pixel to the amount of displacement in the unit of pixels as obtained by representative matching, it is possible to calculate the amount of displacement between the reference and non-reference images.

### Super-Resolution Effect Judgement

In the Practical Example described above, the super-resolution effect is notified by displaying to the user the super-resolution effect image contained in an output image for display. However, when the user is unfamiliar, for example, he/she may not know how to interpret the super-resolution effect image, or may erroneously interpret it. Specifically, even if the super-resolution effect image is displayed, the user may not always perform appropriate operation according to it. Thus, a description will be given of a modified example for helping the user, even if the user is unfamiliar, to perform appropriate operation easily.

### A Modified Example at the Time of Image Recording

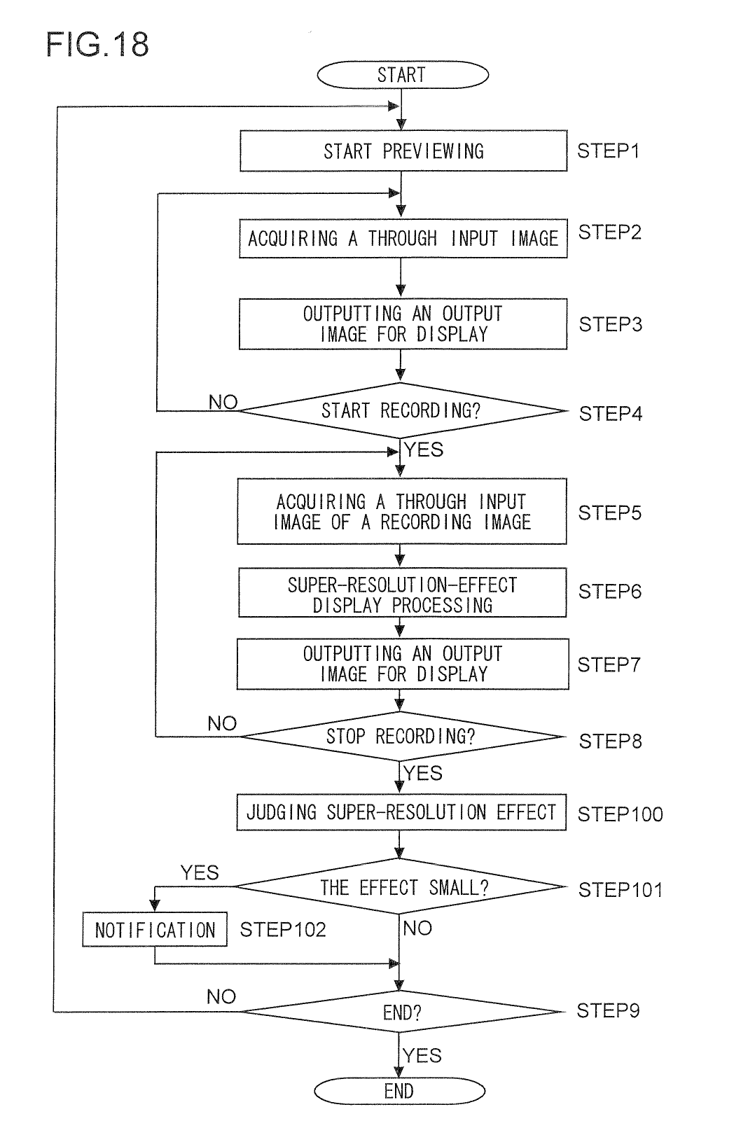

First, the operation of the image-sensing apparatus 1 at the time of image recording will be described with reference to the relevant drawings. FIG. 18 is a flow chart that shows an example of the operation of the output-image processing portion when super-resolution-effect display processing is performed at the time of image recording, and that corresponds to FIG. 3 described earlier. Note that in FIG. 18, the same operation found in FIG. 3 are identified with the same step numerals and no detailed description of them will be repeated.

As described above, and as shown in FIG. 18, previewing is performed before image recording (STEPS 1 through 3, and “NO” at STEP 4), and thereafter image recording starts (“YES” at STEP 4). Along with image recording, an output image for display containing a super-resolution effect image is generated and displayed (STEPS 5 through 7, and “NO” at STEP 8). Then, after confirmation of the user entering a command to stop image recording (e.g., during recording a moving image), recording of a predetermined number of images being ended (for example, at the time of recording a still image), etc., image recording is stopped (“YES” at STEP 8). Note that an output image for display containing a super-resolution effect image may be created and displayed at the time of previewing.

In this modified example, the degree of super-resolution effect is judged for example, after image recording has been stopped (STEP 100). Here, judgment is performed, for example, by use of the degree of super-resolution effect obtained when the super-resolution effect image is created at STEP 6. Note that judgment may be performed during image recording or during previewing.

Specifically for example, judgment is performed based on the degree of super-resolution effect obtained by averaging the super-resolution effect in partial regions (for example, regions at or near the center, or the target regions) or the entire regions in FIGS. 5A to 5C, and FIG. 6B, or the degree achieved by averaging the degree of super-resolution effect shown in FIGS. 7B, 8A, 8B, and 9 for some or all of the plurality of images recorded. When judgment is performed by calculating the degree of super-resolution effect of a moving image in particular, the super-resolution effects of different images (or blocks) may be weighted averaged for a plurality of images (or for a predetermined period) or for one moving image file to calculate the degree of super-resolution effect, and, based on this degree, judgment may be performed. Note that the image-for-display retouching portion 123 or the CPU 15 may perform such judgment.

At STEP 100, whether or not the super-resolution effect is small is judged. Specifically, for example, by use of the super-resolution effect calculated by a method shown in FIG. 7B, and when the threshold value is assumed to be 50%, “the super-resolution effect” is judged “to be small” when the super-resolution effect is at or below 50%.

When the super-resolution effect is small (“YES” at STEP 101), the user is notified accordingly (STEP 102). Here, on the output image for display that is continuously displayed after recording has been stopped (“YES” at STEP 8) for example, messages notifying that “it is recommended to record an image again (to shoot again)” or “even if the recorded image is subjected to super-resolution processing, the super-resolution effect is small, and thus it is not recommended to apply super-resolution processing” may be overlaid to give a notification. Here, a message notifying that the super-resolution effect is small may be written into header information or the like.

The method of giving a notification is not limited to one that uses the output image for display, and any method may be used so long as it can notify the user that the super-resolution effect is small. For example, sound (notification sound, a voice message), vibration, light, etc. may be used to notify. It should be noted, however, that when a notification is given by these methods, a component (such as a speaker for notification, a motor for vibration, and an LED (light emitting diode)) is mounted as required on the image-sensing apparatus 1.

On the other hand, when the super-resolution effect is large (for example, the super-resolution effect is larger than the threshold value mentioned above) (“NO” at STEP 101), whether or not to end without giving a notification at STEP 102 is checked (STEP 9). Also in the case where the super-resolution effect is large, it may be notified accordingly, and a message indicating that the super-resolution effect is large may be written into header information or the like. Moreover, an image having a large super-resolution effect may be recorded in a single file in association with information that it is an image that can be used for super-resolution processing.

With the configuration described above, it is possible to notify the user that the super-resolution effect is small. Thus, even if the user is unfamiliar, it is possible to reduce the need for the user to judge by himself/herself, helping the user to perform operation appropriately.

Moreover, by notifying specific operation contents such as “it is recommended to record an image again” and “it is not recommended to apply super-resolution processing”, it is possible to further help the user to perform operation appropriately. Particularly by notifying that “it is recommended to record an image again”, it is possible to surely record an image in which the super-resolution effect is large. In addition, by notifying that “it is not recommended to apply super-resolution processing”, it is possible to prevent application of super-resolution processing that has a small effect and hence may be wasted.

With respect to images judged to have a large super-resolution effect, super-resolution processing may be executed directly (or later on, without an approval obtained), or the user may be asked for an approval before super-resolution processing is executed and, after an approval is obtained, super-resolution processing may be executed. Moreover, the thus generated super-resolution image and images used in super-resolution processing may be, in association with one another, recorded in a single file.

When the user performs image recording again (“NO” at STEP 9) according to the notification at STEP 102, and if the super-resolution effect is judged to be large (“NO” at STEP 101), the recorded image may be deleted before recording is performed again. Whereas if the super-resolution effect is judged to be small (“YES” at STEP 101), “Record image again” may be notified again (STEP 102). Here, the super-resolution effect on the image recorded last time may be compared with that on the image recorded this time, and the image having a larger super-resolution effect may be recorded and the image having a smaller super-resolution effect may be deleted; alternatively, both of the images may be recorded. Moreover, the image having a larger super-resolution effect may be subjected to super-resolution processing as described above, and a message indicating that the super-resolution effect is (relatively) large may be written into header information.

### A Modified Example at the Time of Image Playback

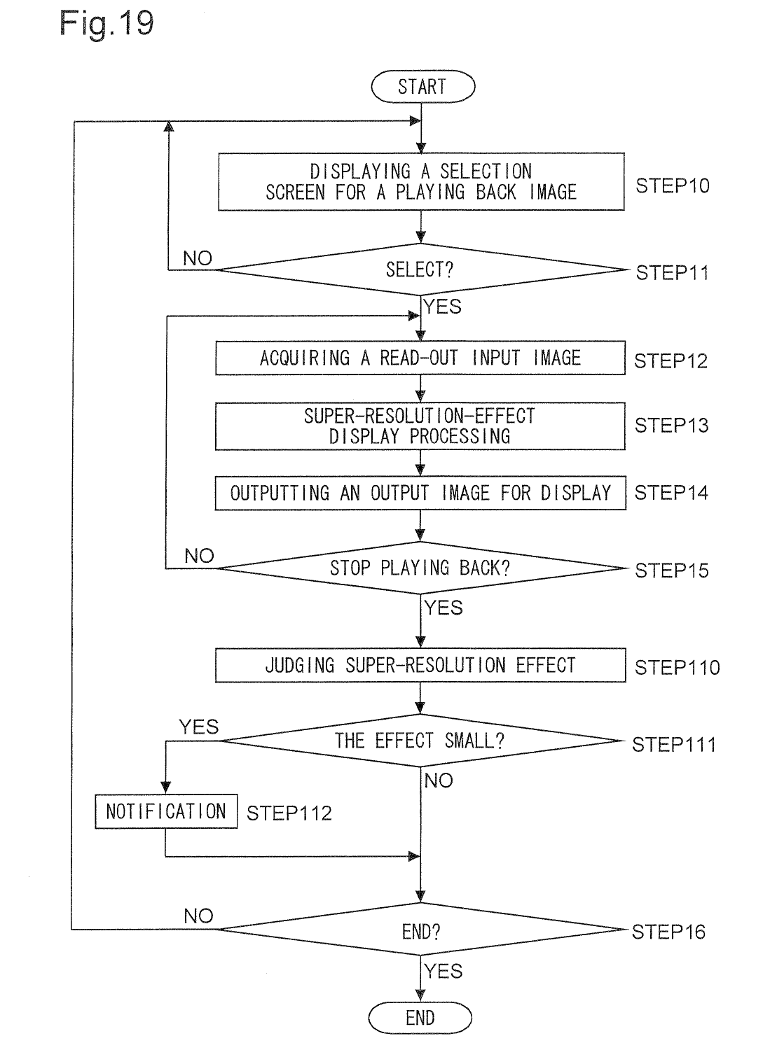

Next, the operation of the image-sensing apparatus 1 at the time of image playback will be described with reference to the relevant drawings. FIG. 19 is a flow chart that shows an example of the operation of the output-image processing portion when super-resolution-effect display processing is performed at the time of image playback, and that corresponds to FIG. 4 described earlier. Note that in FIG. 19, the same operation found in FIG. 4 are identified with the same step numerals and no detailed description of them will be repeated.

As described above, and as shown in FIG. 19, before playback operation is performed, a screen is displayed that allows the user to select an image to playback (STEP 10, and “NO” at STEP 11), and the user selects the image to playback (“YES” at STEP 11). Then, the output-image processing portion 12 acquires a read-out input image, and then an output image for display containing a super-resolution effect image is generated and displayed (STEPS 12 through 14, and “NO” at STEP 15). Then, for example, if the user enters a command to stop image playback, playback is stopped (“YES” at STEP 15).

In this modified example, after image playback is stopped for example, the degree of super-resolution effect is judged (STEP 110). The judging method is similar to that used at the time of image recording described above (see STEP 100 in FIG. 18). Note that the judgment may be performed during image playback.

If the super-resolution effect is small (“YES” at STEP 111), the user is notified accordingly (STEP 112). Here, on an output image for display that is continuously displayed after playback has been stopped (“YES” at STEP 15) for example, a message notifying that “even if the recorded image is subjected to super-resolution processing, the super-resolution effect is small, and thus it is not recommended to apply super-resolution processing” may be overlaid, so as to give a notification. Moreover, as during image recording described above, a notification may be given by use of sound, vibration or light. Likewise, a message indicating that the super-resolution effect is small may be written into header information etc.

On the other hand, if the super-resolution effect is large (for example, the super-resolution effect is larger than the threshold value mentioned above) (“NO” at STEP 111), whether or not to end is checked (STEP 16) without giving a notification at STEP 112. Note that even when the super-resolution effect is large, a corresponding message may be notified, and a message indicating that the super-resolution effect is large may be written into header information etc. Moreover, an image in which the super-resolution effect is large may be recorded in a single file in association with information that it is an image that can be used for super-resolution processing.

With the configuration described above, it is possible to notify the user that the super-resolution effect is small. Thus, even if the user is unfamiliar, it is possible to reduce the need to judge by himself/herself, helping the user to perform operation appropriately.

Moreover, by notifying specific operation contents such as “it is not recommended to apply super-resolution processing”, it is possible to further help the user to perform operation appropriately. Particularly by notifying that “it is not recommended to apply super-resolution processing”, it is possible to prevent performance of super-resolution processing that has a small effect and hence may be wasted.

With respect to images judged to have a large super-resolution effect, super-resolution processing may be executed directly (or later on, without an approval obtained), or the user may be asked for an approval before super-resolution processing is executed and, after an approval is received, super-resolution processing may be executed. Moreover, the thus generated super-resolution image and images used for super-resolution processing may be, in association with one another, recorded in a single file.

Even in a case where the image selected at STEP 11 is a super-resolution image, similar playback processing can be performed. At this time, in STEP 11 for example, a message indicating that “the image to be played back is a super-resolution image” may be notified. Furthermore, at this time, on judging the super-resolution effect at STEP 111, if the super-resolution effect is judged to be large (“NO” at STEP 111) when further super-resolution processing is applied, a message indicating that “it is recommended that further super-resolution processing be applied” may be notified.

### Other Modified Examples

Although an image-sensing apparatus has been taken up as one example of an electronic appliance according to the present invention for description, the electronic appliance according to the invention is not limited to the image-sensing apparatus. For example, the electronic appliance may have playback or recording capability alone, and may generate a super-resolution image by acquiring an input image from outside (for example, a recording medium such as an optical disk), so as to record or to display. That is, the electronic appliance according to the invention may be a playback apparatus or an editing apparatus. It should be noted, however, that an output image for display is displayed to the user as described above, so as to notify the super-resolution effect.

With respect to the image-sensing apparatus embodying the invention, the respective operation of the input-image processing portion 6, the output-image processing portion 12, and the like may be performed by a control device such as a microcomputer. Furthermore, all or part of the capability realized by such a control device may be prepared in the form of a program so that, when the program is executed on a program execution device (for example, a computer), all or part of the capability is realized.

Cases described above are not meant to be any limitation; the image-sensing apparatus 1 and the input-image processing portion 6 in FIG. 1, and the output-image processing portion 12 in FIGS. 1 and 2 can be realized in hardware, or in a combination of hardware and software. In addition, in a case where the image-sensing apparatus 1, the input-image processing portion 6, and the output-image processing portion 12 are built with software, a block diagram showing the part realized in software serves as a functional block diagram of that part.

It is to be understood that the present invention may be carried out in any other manner than specifically described above as an embodiment, and many modifications and variations are possible within the scope of the present invention.

The present invention relates to an image processing apparatus that applies predetermined processing to an input image and outputs an output image. The invention also relates to an electronic appliance such as an image-sensing apparatus exemplified by a digital video camera and the like provided with such an image processing apparatus.

What is claimed is:

1. An image processing apparatus comprising:
an image-for-display retouching portion adapted
to generate a super-resolution-effect image, which indicates an effect obtained when super-resolution processing, which is processing for enhancing a resolution of an input image, is applied to an input image fed to the image processing apparatus, and
to generate, as an output image for display, an image containing the super-resolution-effect image.

2. The image processing apparatus according to claim 1,
wherein the super-resolution-effect image is an image which indicates a degree of resolution enhancement when the super-resolution processing is applied to the input image, and
wherein the image-for-display retouching portion adds the super-resolution-effect image to the input image to generate the output image for display.

3. The image processing apparatus according to claim 1,
wherein the image-for-display retouching portion generates, based on definition in each predetermined location in the input image, the super-resolution-effect image corresponding to that predetermined location in the input image.

4. The image processing apparatus according to claim 1,
wherein the input image comprises a plurality of input images and the super-resolution processing is processing for adjusting positions of and merging together the plurality of input images, and
wherein the image-for-display retouching portion generates the super-resolution-effect image based on a positional relationship among the plurality of input images having undergone the position adjustment which are to be used in the super-resolution processing.

5. The image processing apparatus according to claim 1,
wherein the image-for-display retouching portion uses, as the super-resolution-effect image, an image having combined together
a local super-resolution image generated by applying the super-resolution processing to a target region, which is a partial region of the input image, and
a local input image indicating the target region of the input image, and
wherein the target region is a region where a degree of resolution enhancement when the super-resolution processing is applied to the input image is higher than elsewhere.

6. An electronic appliance comprising:
the image processing apparatus according to claim 1;
a display device adapted to display the output image for display, which is outputted from the image processing apparatus; and
a super-resolution processing portion adapted to apply the super-resolution processing to the input image to generate a super-resolution image,
wherein the super-resolution image is recorded or played back.

7. The electronic appliance according to claim 6, further comprising:
a judgment portion adapted to judge whether or not a degree of effect obtained when the super-resolution processing is applied to the input image is equal to or less than a predetermined degree; and
a notification portion adapted to gives a notification to a user when the judgment portion judges that the degree of effect obtained when the super-resolution processing is applied to the input image is equal to or less than the predetermined degree.

8. The electronic appliance according to claim 7, further comprising:
an image-sensing portion adapted to acquire the input image by shooting,
wherein when the judgment portion judges that the degree of effect obtained when the super-resolution processing is applied to the input image is equal to or less than the predetermined degree, the notification portion gives a notification to recommend acquisition of a new input image by shooting.

9. The electronic appliance according to claim 7,
wherein when the judgment portion judges that the degree of effect obtained when the super-resolution processing is applied to the input image is equal to or less than the predetermined degree, the notification portion gives a notification to recommend not to apply the super-resolution processing.
